(19) United States
(12) Patent Application Publication
(10) Pub. No.: US 2002/0020277 A1
(43) Pub. Date: Feb. 21, 2002

(54) Holder for a jig saw

(76) Inventor: Raymond Anthony Nuzzo, East Haven, CT (US)

Correspondence Address: Raymond A. Nuzzo, P.O. Box 120588, East Haven, CT, 06512, US

(21) Appl. No.: 09/794,774

(22) Filed: Feb. 27, 2001

Related U.S. Application Data
(63) Continuation-in-part of application No. 09/399,313, filed on Sep. 20, 1999.
(60) Provisional application No. 60/185,229, filed on Feb. 28, 2000.

(51) Int. Cl. B26D 7/00

(52) U.S. Cl. 83/781; 83/574; 83/581; 83/750

(57) ABSTRACT

A holder for a jig saw. The jig saw holder has a pair of opposing support members movably attached to the base member such that the support members can be moved toward or away from one another. Each support member has a jig saw receiving surface for receiving a first portion of the base of a jig saw. The support members are spaced apart from each other so as to define a region for receiving a blade of the jig saw when each jig saw receiving surface receives a corresponding portion of the base of the jig saw. The jig saw holder also includes a pair of adjustable members. Each adjustable members is movably attached to a corresponding support member adjacent to the jig saw receiving surface of that support member. Each adjustable member and the corresponding jig saw receiving surface cooperating to define a jig saw base receiving region for receiving a portion of the base of the jig saw. The position of each adjustable member is adjustable so as to vary the size of the jig saw receiving region.

This application is a continuation-in-part application and claims the benefit of the filing date of commonly owned and co-pending U.S. application Ser. No. 09/399,313, filed Sep. 20, 1999. This application also claims the benefit of the filing date of commonly owned and co-pending U.S. provisional patent application Ser. No. 60/185,229, filed Feb. 28, 2000.

### BACKGROUND OF THE INVENTION

1. Field of the Invention

The present invention generally relates to a holder for a jig saw or saber saw.

2. Problem to be Solved

Jig saws, also known as saber saws, are electrically powered saws that have a reciprocating blade. Jig saws are used in the construction industry and by homeowners. When a user of a jig saw is in the midst of a construction or home improvement project, the user periodically uses the saw to cut wood. After the wood is cut, the user typically lays the saw down on its side because the protruding saw blade prevents the user from placing the saw in an upright position. Such a practice can be lead to injury to the user or other personnel. For example, the user can cut himself on the exposed blade of the saw if he reaches to grasp the saw without watching where his or her hand is actually going. Furthermore, if the saw is accidentally activated, the vibrations of the internal motor of the saw will cause the saw to move erratically on the ground or floor thereby making it difficult to deactivate the saw. Such a scenario can lead to serious injury to the user. Additionally, the reciprocating blade can be damaged by constantly placing the saw on its side or in other awkward positions.

Therefore, it is an object of the present invention to provide a holder for a jig saw.

It is another object of the present invention to provide a holder for a jig saw that is simple to use, easy to transport and easy to store.

Other objects and advantages of the present invention will be apparent to one of ordinary skill in the art in light of the ensuing description of the present invention.

### SUMMARY OF THE INVENTION

The present invention is directed to a holder for a jig saw. The jig saw holder comprises a pair of opposing support members movably attached to the base member such that the support members can be moved toward or away from one another. Each support member has a jig saw receiving surface for receiving a first portion of the base of a jig saw. The support members are spaced apart from each other so as to define a region for receiving a blade of the jig saw when each jig saw receiving surface receives a corresponding portion of the base of the jig saw. The jig saw holder also includes a pair of adjustable members. Each adjustable members is movably attached to a corresponding support member adjacent to the jig saw receiving surface of that support member. Each adjustable member and the corresponding jig saw receiving surface cooperating to define a jig saw base receiving region for receiving a portion of the base of the jig saw. The position of each adjustable member is adjustable so as to vary the size of the jig saw receiving region.

In an alternate embodiment, the jig saw holder of the present invention comprises a body having a surface for receiving a base of a jig saw and defining a generally vertically extending cavity sized for receiving at least a portion of a blade of the jig saw when the base of the jig saw is positioned upon the surface of the body, The body further comprises a first wall and a second wall which upwardly extend from the surface of the body. The first wall is positioned on one side of the cavity. The second wall is positioned on the other side of the cavity. The walls and surface of the body cooperate to define a jig saw base receiving region.

In a further embodiment, the jig saw holder of the present invention comprises a body having a surface for receiving a base of a jig saw and defining a longitudinally extending slot having a depth sufficient for receiving at least a portion of a blade of the jig saw when the base of the jig saw is positioned upon the surface of the body. The body further comprises a pair of guides movably attached to the body and positioned upon the surface of the body. One guide is positioned on one side of the slot and the other guide is positioned on the other side of the slot. The guides and surface of the body cooperate to define a jig saw base receiving region such that the base of the jig saw is between the guides when the jig saw base is positioned upon the surface of the body.

### BRIEF DESCRIPTION OF THE DRAWINGS

FIG. 1 is a side elevational view of the saw holder of the present invention

FIG. 2 is an end view taken along line 2-2 of FIG. 1.

FIG. 3 is a side elevational view, similar to FIG. 1, of the opposite side of the saw holder of FIG. 1

FIG. 4 is a top view taken along line 4-4 of FIG. 3.

FIG. 5A is a side elevational of one type of jig saw with which the holder of FIG. 1 can be used.

FIG. 5B is a bottom view taken along line 5B-5B of FIG. 5A.

FIG. 5C is a view taken along line 5C-5C of FIG. 5A.

FIG. 6 is a side elevational view showing the jig saw of FIG. 5A mounted on the holder of FIG. 1.

FIG. 7 is an end view taken along line 7-7 of FIG. 6.

FIG. 8 is an end view, similar to FIG. 2, showing lateral support members attached to the saw holder of FIG. 1.

FIG. 9 is a top plan view of the saw holder shown in FIG. 8.

FIG. 10 is an end view, similar to FIG. 2, of an alternate embodiment of the saw holder of the present invention

FIG. 11 is a top plan view of the alternate embodiment of FIG. 10.

FIG. 12 is a top plan view of an alternate embodiment of the lateral support members originally depicted in FIGS. 10 and 11.

FIG. 13 is a top plan view of the saw holder of 10 having attached thereto the lateral support members of FIG. 12.

FIG. 14A is a perspective view of another embodiment of the saw holder of the present invention.

FIG. 14B is an end view of the saw holder of FIG. 14A.

FIG. 15 is a plan view of the saw holder of FIG. 14A.

FIG. 16A is a perspective view of an alternate embodiment of the saw holder of the present invention.

FIG. 16B is an end view of the saw holder of FIG. 16A.

FIG. 16C is a side elevational view taken along line 16C-16C of FIG. 16B.

FIG. 16D is a side elevational view taken along line 16D-16D of FIG. 16B.

FIG. 16E is a top plan view of the saw holder of FIG. 16A.

FIG. 16F is a side elevational view showing the jig saw of FIG. 5A mounted on the saw holder of FIG. 16A.

FIG. 16G is an end view taken along line 16G-16G of FIG. 16F.

FIG. 17A is an end view of a further embodiment of the saw holder of the present invention.

FIG. 17B is a top plan view of the saw holder of FIG. 17A.

FIG. 17C is a side elevational view taken along line 17C-17C of FIG. 17A.

FIG. 18 is an end view, similar to FIGS. 16B and 17A, of an alternate embodiment of the saw holder of the present invention.

FIG. 18A is a top plan view taken along line 18A-18A of FIG. 18.

FIG. 18B is a side elevational view taken along line 18B-18B of FIG. 18A.

FIG. 19 is an end view, similar to FIGS. 16B and 17A, of an alternate embodiment of the saw holder of the present invention.

FIG. 19A is a plan view taken along line 19A-19A of FIG. 19.

FIGS. 20-22 are end views, similar to FIGS. 16B and 17A, of alternate embodiments of the saw holder of the present invention.

FIG. 23 is a side elevational view of one side of a further embodiment of the saw holder of the present invention.

FIG. 24 is a side elevational view of the opposite side of the saw holder of FIG. 23.

FIG. 25 is a view taken along line 25-25 in FIG. 23.

FIG. 25A is an end view, similar to FIG. 25, showing a jig saw mounted on the saw holder of FIG. 23 and angulated with respect to the base of the jig saw in order to make an angled cut of a work piece.

FIG. 26 is a view taken along line 26-26 in FIG. 23.

FIG. 27 is a top plan view of the saw holder of FIG. 23.

FIG. 28 is an end view of the saw holder of FIG. 23, similar to FIG. 25, that shows a work piece secured by the saw holder.

FIG. 29 is a top plan view of the saw holder of FIG. 23, similar to FIG. 27, that shows a work piece secured by the saw holder.

FIG. 29A is top plan view of the saw holder of FIG. 23, similar to FIG. 29, showing the work piece positioned at an angle.

FIG. 30 is a side elevational view of the saw holder of FIG. 23 showing a jig saw securely mounted on one portion of the saw holder.

FIG. 31 is a side elevational view of the saw holder of FIG. 23, similar to FIG. 30, that shows the jig saw cutting a work piece on another portion of the saw holder.

FIGS. 32-35 are end views, similar to FIGS. 20-22, of alternate embodiments of the saw holder of the present invention.

FIG. 36 is a perspective view of another embodiment of the saw holder of the present invention.

FIG. 37 is a top plan view of the saw holder of FIG. 36.

FIG. 38 is a side elevational view of the saw holder of FIG. 36 wherein an interior region is shown in phantom.

FIG. 39 is a cross-sectional view taken along line 39-39 of FIG. 37 showing a jig saw disposed within the jig saw receiving region shown

FIG. 39A is a perspective view of the saw holder of FIG. 37 showing a jig saw disposed within the interior region.

FIG. 40 is a perspective view of another embodiment of the saw holder of the present invention.

FIG. 41 is an end view of the saw holder of FIG. 40.

FIG. 41A is a plan view of the saw holder of FIG. 40 without having guides attached thereto.

FIG. 42A is an end view of a guide depicted in FIGS. 40 and 41.

FIG. 42B is a side elevational view of the guide shown in FIG. 42A.

FIG. 42C is an end view of an alternate guide.

FIG. 43 is a top plan view taken along line 43-43 of FIG. 41.

FIG. 44 is an end view of the saw holder FIG. 40 and a jig saw which is mounted thereon.

FIG. 45 is a perspective view of a further embodiment of the saw holder of the present invention.

FIG. 46 is a end view of the saw holder of FIG. 45 having a jig saw mounted thereon.

FIG. 47 is an end view of an alternate embodiment of the jig saw holder of the present invention.

FIG. 48 is a side elevational view taken along line 48-48 in FIG. 47.

FIG. 48A is a view similar to that shown in FIG. 48 illustrating optional features that may be used with the embodiment of the invention shown in FIG. 47.

FIG. 49 is a front elevational view of a bracket shown in FIG. 47.

FIG. 50 is a view taken along line 50-50 in FIG. 49.

FIG. 51 is a top plan view of the saw holder of FIG. 47.

FIG. 52 is top plan view of an alternate base member.

### DESCRIPTION OF THE PREFERRED EMBODIMENTS

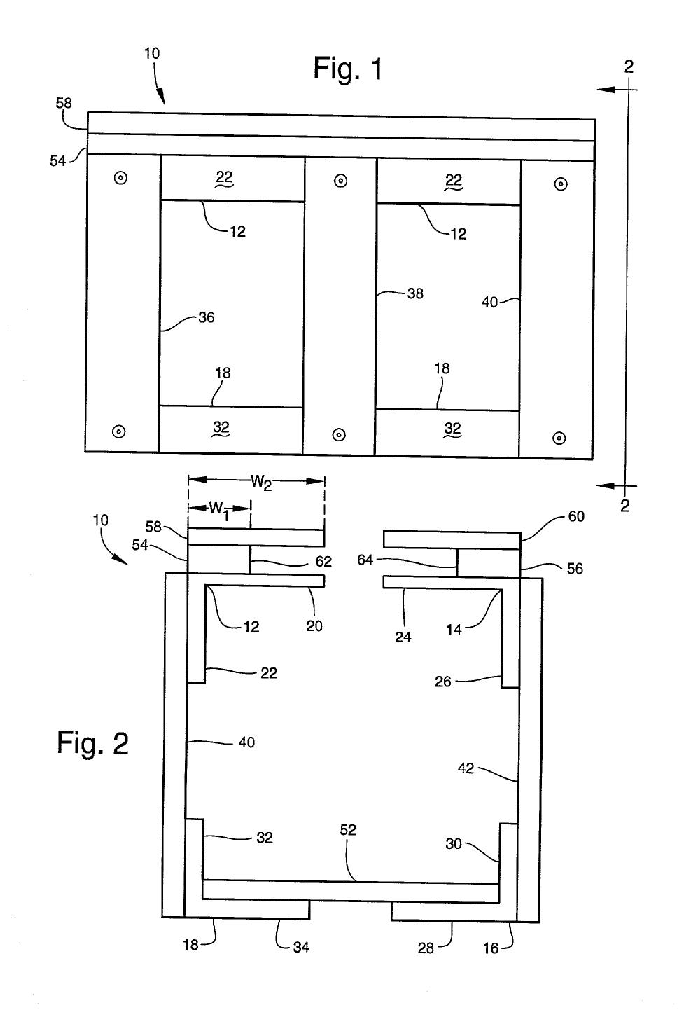

Referring to FIGS. 1 and 2, saw holder 10 comprises four (4) elongate support members 12, 14, 16 and 18. Elongate member 12 comprises portion 20 and portion 22. Portion 22 is contiguous with portion 20. Portion 20 is angulated with respect to portion 22. In a preferred embodiment, portion 20 is angulated about 90 with respect to portion 22. Similarly, elongate member 14 is comprised of portion 24 and portion 26. Portion 26 is contiguous with portion 24. Portion 24 is angulated with respect to portion 26. In a preferred embodiment, portion 24 is angulated about 90 with respect to portion 26. Similarly, portion 16 comprises portion 28 and portion 30. Portion 30 is contiguous with portion 28. Portion 28 is angulated with respect to portion 30. In a preferred embodiment, portion 28 is angulated about 90 with respect to portion 30. Elongate member 18 comprises portions 32 and 34. Portion 34 is contiguous with portion 32. Portion 32 is angulated with respect to portion 34. In a preferred embodiment, portion 32 is angulated about 90 with respect to portion 34.

Referring to FIG. 1, saw holder 10 further comprises members 36, 38 and 40. Members 36, 38 and 40 are attached to and between elongate members 12 and 18. Specifically, member 36, 38 and 40 are attached to and between portion 22 of elongate member 12 and portion 32 of elongate member 18.

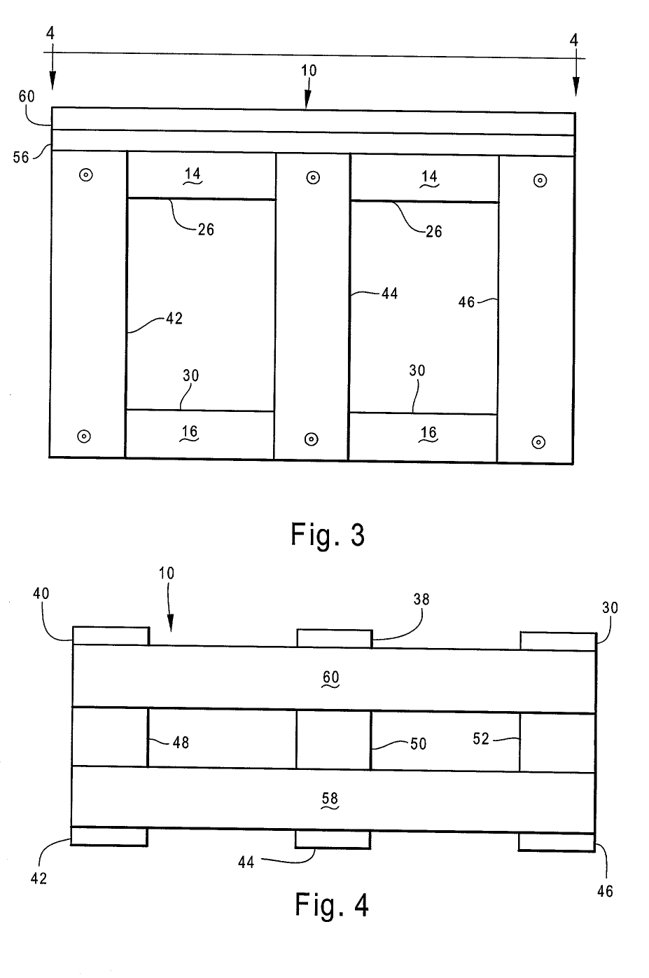

Referring to FIG. 3, saw holder 10 further includes members 42, 44 and 46 that are attached to and between elongate members 14 and 16. Specifically, members 42, 44 and 46 are attached to and between portion 26 of elongate member 14 and portion 30 of elongate member 16.

Referring to FIG. 4, saw holder 10 further comprises lateral support or base members 48, 50 and 52. In a preferred embodiment, the axes of members 48, 50 and 52 are substantially perpendicular to the axes of elongate members 12, 14, 16 and 18. Specifically, members 48, 50 and 52 are attached to and between portion 28 of elongate of elongate member 16 and portion 34 of elongate member 18.

Referring to FIGS. 2 and 4, saw holder 10 further comprises elongate members 54 and 56. Member 54 is attached to portion 20 of elongate member 12. The axis of elongate member 54 is substantially parallel to the axis of elongate member 12. Similarly, member 56 is attached to portion 24 of member 14. The axis of elongate member 56 is substantially parallel to the axis of elongate member 14. Each member 54 and 56 has a width W1.

Referring to FIGS. 2 and 4, saw holder 10 further includes elongate member 58 that is attached to elongate member 54. Member 58 has a longitudinally extending axis that is substantially parallel to the axis of elongate member 54. Saw holder 10 further includes elongate member 60 that is attached to elongate member 56. Member 60 has a longitudinally extending axis that is substantially parallel to the axis of elongate member 56. Each member 58 and 60 has a width W2. Portions 20 and 24 of members 12 and 14, respectively, each have a width W2. Width W2 is greater than width W1. The difference in widths between members 54 and 58, and between member 54 and portion 20, results in the creation of longitudinally extending channel 62. Similarly, the difference in widths between member 56 and member 60, and between member 56 and portion 24, results in the creation of longitudinally extending channel 64. The purpose of channels 62 and 64 will be discussed below. As shown in FIG. 2, the width W2 of portions 20, 24, and members 58, 60, creates a longitudinally extending channel or gap generally indicated by numeral 66. The purpose of channel 66 will be discussed in detail below.

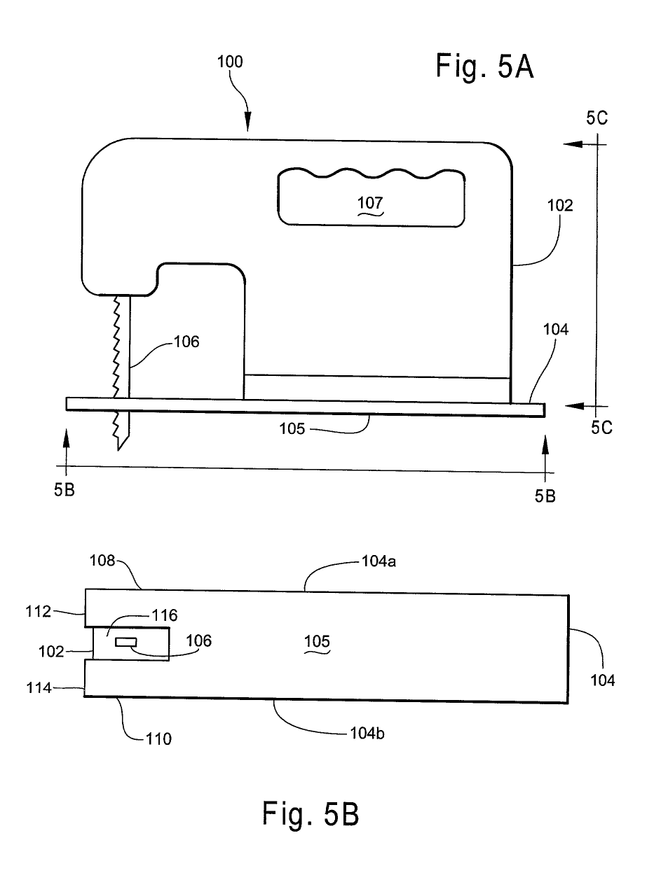

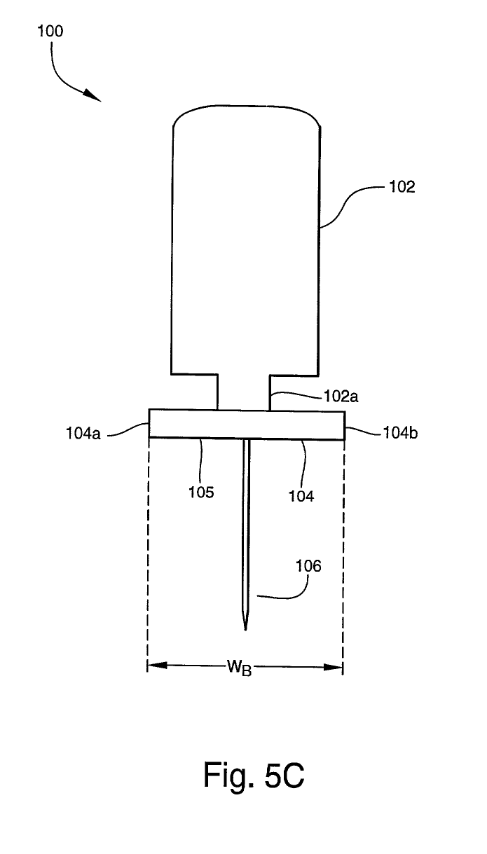

Referring to FIGS. 5A-C, there is shown jig saw 100. Saw 100 comprises body 102, base 104, bottom surface 105 and reciprocating blade 106. Body 102 includes opening 107 to allow a user to grasp saw 100. Base 104 has longitudinally extending edges 104a and 104b. Base 104 further includes portions 108 and 110. Portion 108 includes distal end 112. Similarly, portion 110 includes distal end 114. As shown in FIG. 5A, portions 108 and 110 are separated by space or gap 116. Reciprocating blade 106 extends thorough space 116.

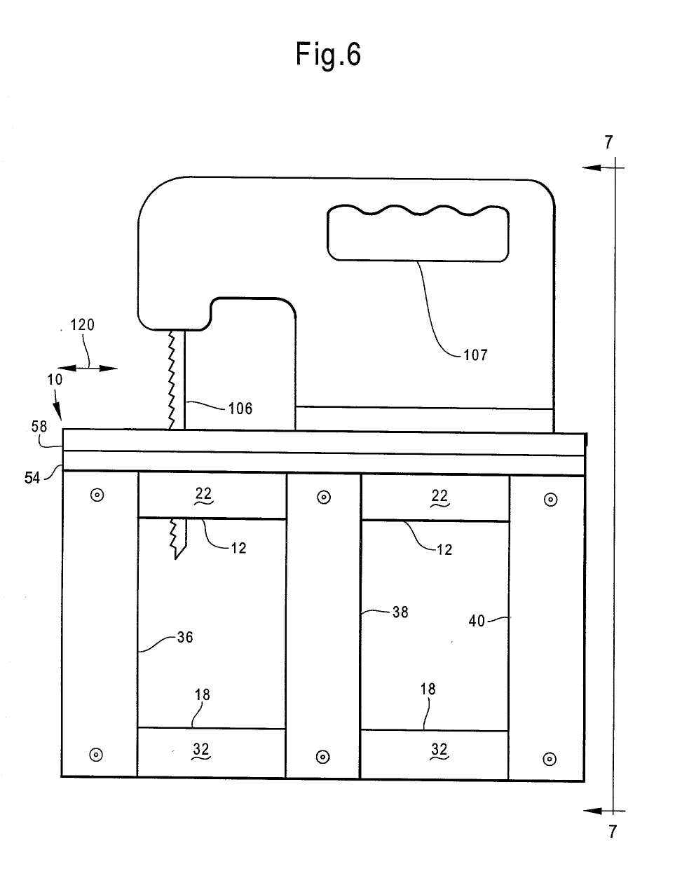

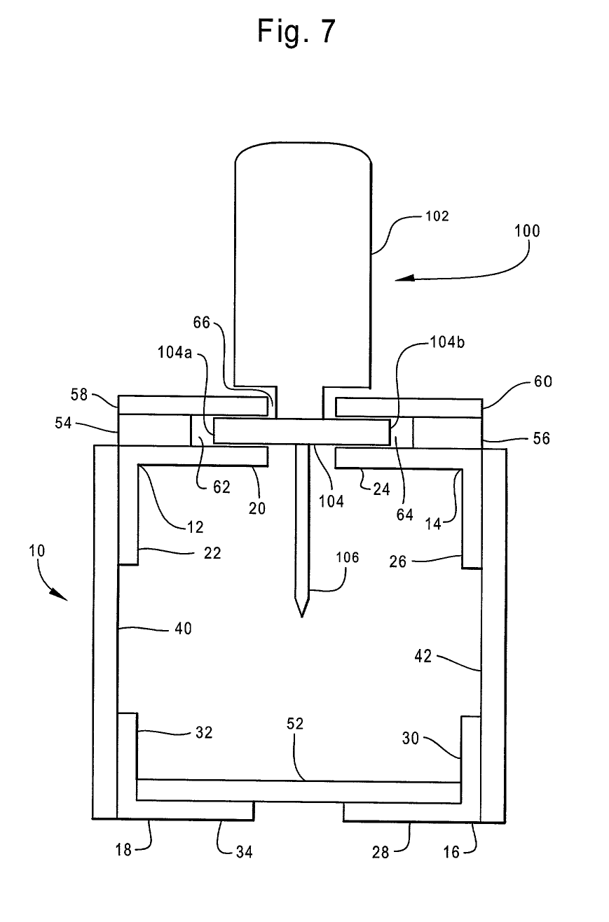

Referring to FIGS. 2 and 5A-7, in order to mount jig saw 100 on saw holder 10, the user grasps saw 100 and maneuvers or positions saw 100 so that distal ends 112 and 114 of portions 108 and 110, respectively, are inserted into extending channels 62 and 64, respectively. Since saw holder 100 is symmetrically designed, the user can insert distal ends 112 and 114 into longitudinally extending channels 62 and 64, respectively, from either end of saw holder 10. Channels 62 and 64 are sized to receive edge portions 104a and 104b of base 104. However, the size of channels 62 and 64 allows edge portions 104a and 104b, respectively, to be easily and freely moved in a longitudinal direction as indicated by arrow 120 in FIG. 6. The user then moves saw 100, relative to saw holder 10, in a manner such that longitudinally extending edge portions 104a and 104b are fully disposed within channels 62 and 64, respectively, and portions of bottom surface 105 rest upon portions 20 and 24, as shown in FIGS. 6 and 7.

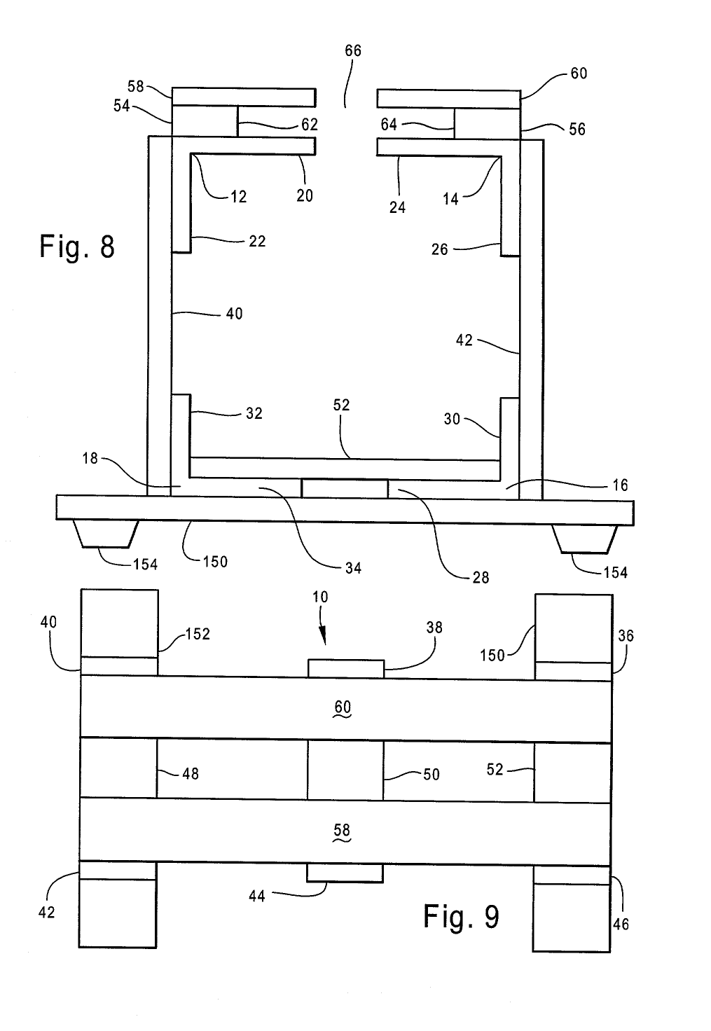

Referring to FIGS. 8 and 9, in an alternate embodiment, saw holder 10 further includes elongate support lateral members 150 and 152. Lateral support members 150 and 152 provide further stability when saw 100 is mounted to holder 10. Specifically, members 150 and 152 prevent saw holder 10 from tipping over if a jig saw of inordinate size or weight is mounted to holder 10. Elongate members 16 and 18 are attached to elongate support members 150 and 152. Specifically, portion 28 of member 16 and portion 34 of portion 18 are attached to elongate members 150 and 152. Member 150 includes a pair of cleats 154 attached to the underside of member 150. Cleats 154 are located at opposite ends of member 150. Similarly, member 152 includes a pair of cleats (not shown) attached to the underside of member 152 and located at opposite ends of member 152. Cleats 154 contact the ground, floor, etc. In a preferred embodiment, cleats 154 are fabricated from a material that has a relatively high coefficient of friction, e.g. rubber, so as to prevent saw holder 10 from sliding along the surface upon which holder 10 is placed.

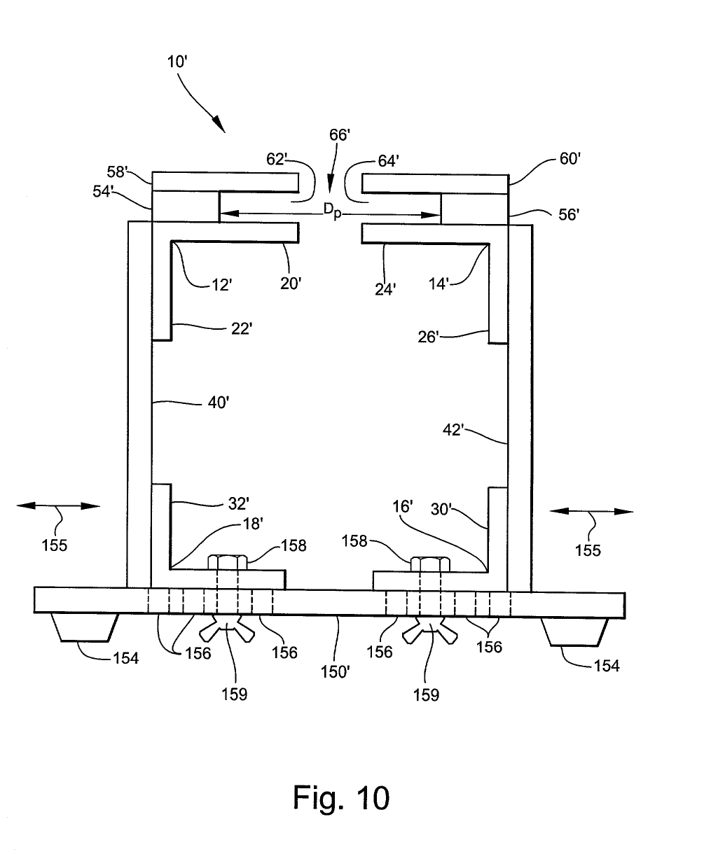

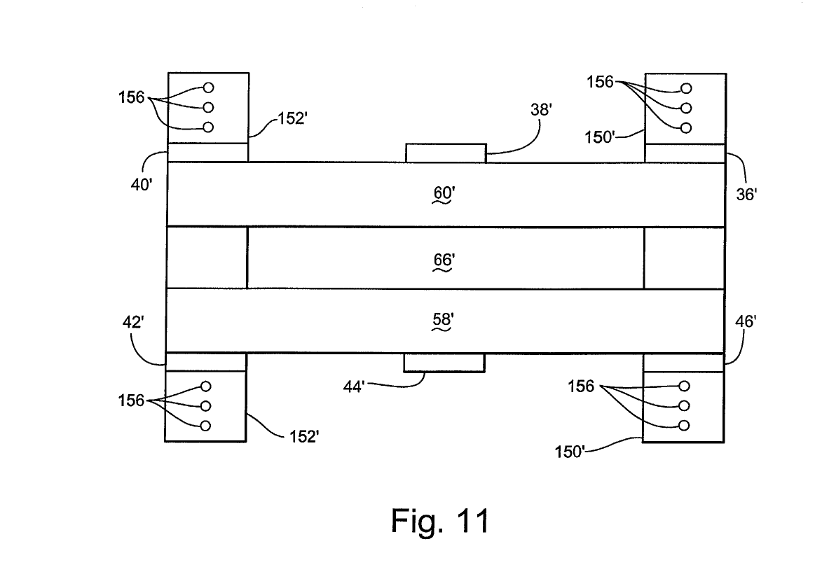

Referring to FIGS. 10 and 11, there is shown an alternate saw holder 10. Saw holder 10 is substantially identical in construction to saw holder 10 except that lateral support members 48, 50 and 52 are not used and members 16 and 18, which correspond to members 16 and 18, respectively, of saw holder 10, are removably attached to members 150 and 152, respectively. With such a configuration, saw holder 10 is separated into two saw holder portions wherein one portion comprises 12, 18, 36, 38, 40, 54 and 58 and the other portion comprises 14, 16, 42, 44, 46, 56 and 60. The distance Dp represents the distance between the aforementioned saw holder portions. Such a configuration allows these two separate portions to be moved laterally, as indicated by arrows 155, to vary the distance Dp in order to accommodate jig saws of varying widths W_{B} (see FIG. 5C). As shown in FIGS. 10 and 11, elongate lateral support members 150 and 152 have a plurality of equidistant apertures 156 sized for receiving screws 158 or other fastening devices. The apertures 156 are arranged longitudinally along members 150′ and 152′. Nuts 159 are threadedly engaged to screws 158. In a preferred embodiment, screws 158 are machine-type screws and nuts 159 are configured as wing nuts. In such a configuration, members 16 and 18 each have apertures for receiving the aforementioned screws. Thus, members 16 and 18 can be removably fastened to a predetermined location upon elongate support members 150 and 152. In one embodiment, elongate support members 150 and 152 have indicia thereon representing various widths of jig saws to facilitate the appropriate placement of members 16 and 18 upon members 150 and 152. In an alternate embodiment, clamps can be used to fasten members 16 and 18 to members 150 and 152.

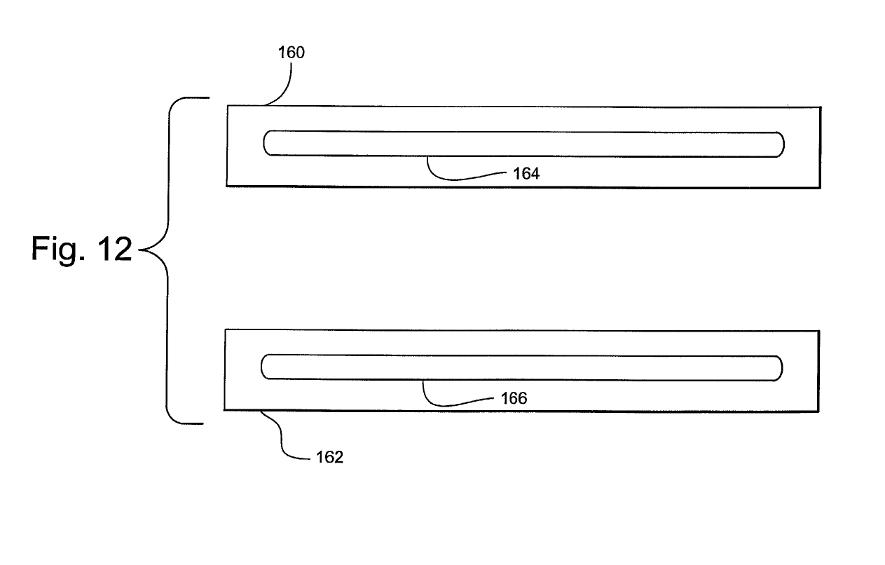

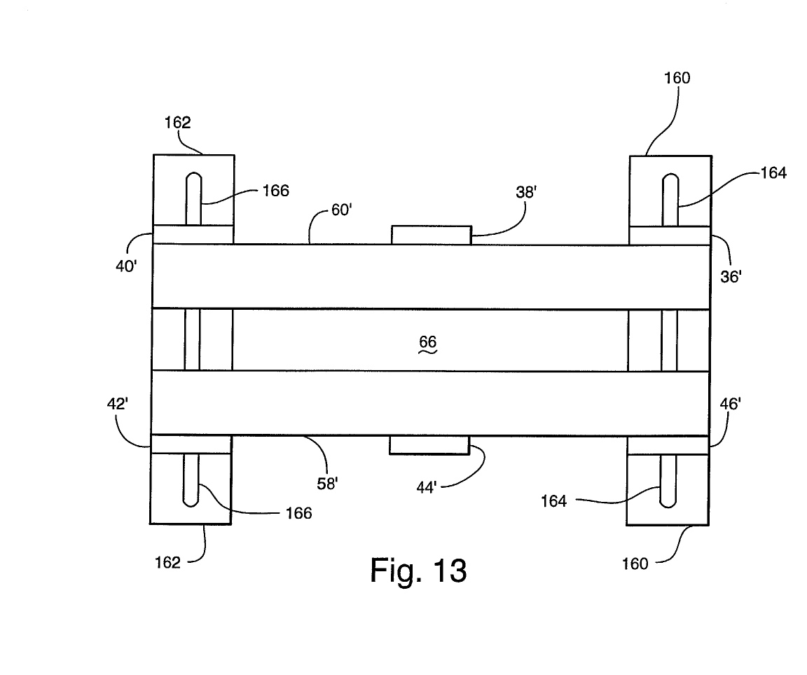

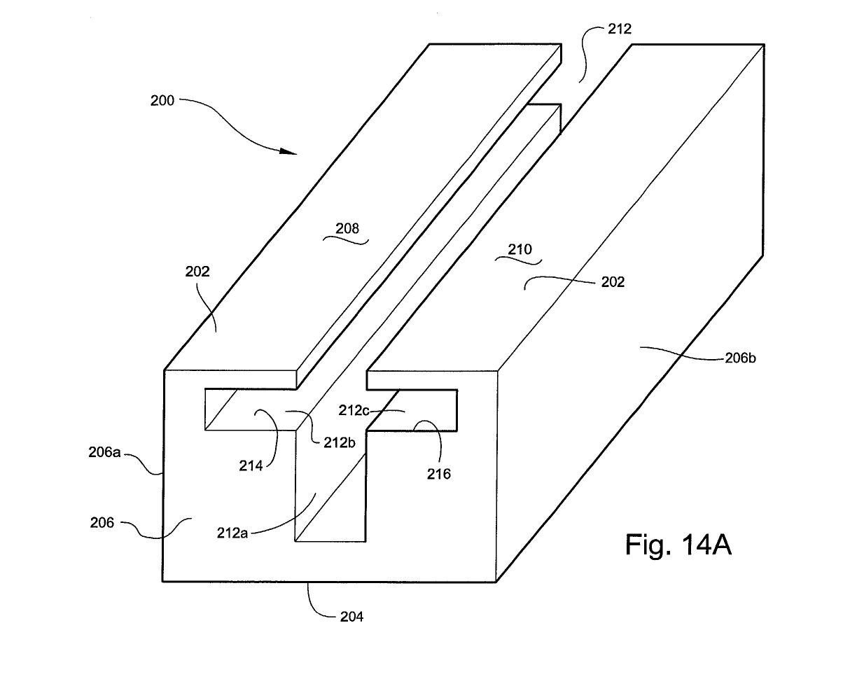

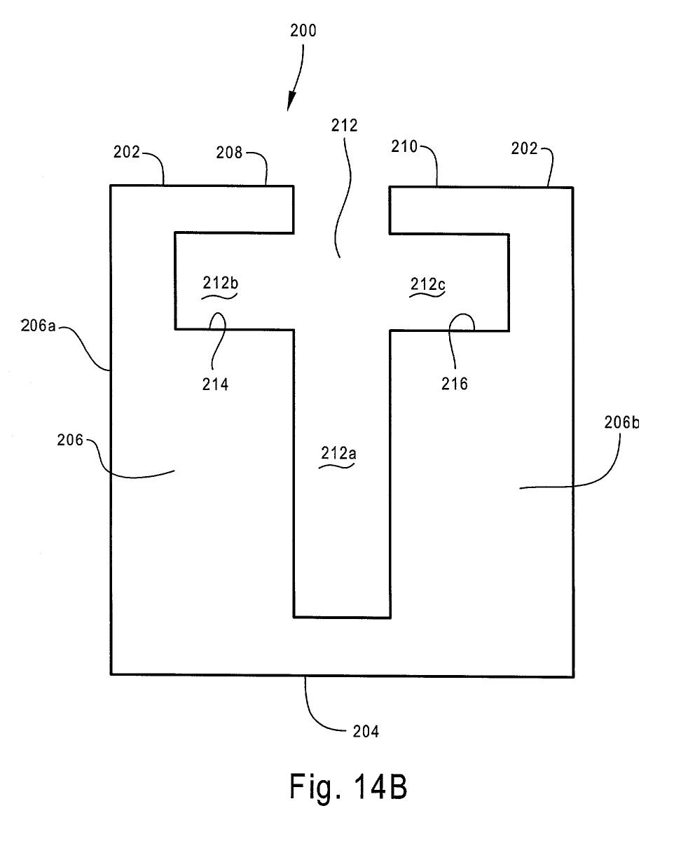

Referring to FIGS. 12 and 13, alternate elongate lateral support or base members 160 and 162 can be used in place of members 150 and 152, respectively. Member 160 has longitudinally extending slot 164 that is sized for receiving screws 158. Similarly, member 162 has longitudinally extending slot 166 that is sized for receiving screws 158. In such an embodiment, the screws can be slightly loosened and the saw holder portions can be moved in the direction indicated by arrows 155 (see FIG. 10) to arrive at a particular distance Dp that allows the particular jig saw in question to be correctly mounted to saw holder 10. When saw 100 is mounted to saw holder 10′, edges 104a and 104b are fully disposed within channels 62′ and 64′, respectively, and portions of bottom surface 105 rests upon portions 20′ and 24′.

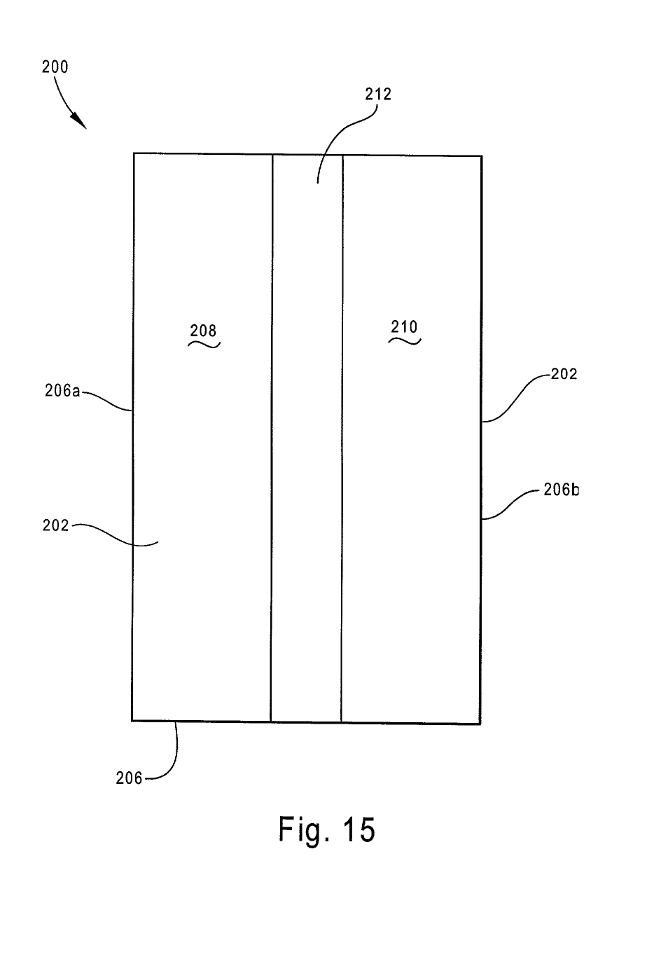

Referring to FIGS. 14A, 14B and 15, there is shown a further embodiment of the saw holder of the present invention. Saw holder 200 is of uni-body construction which can be realized by plastic injection molding. Saw holder 200 can also be made from materials such as wood, rubber, fiberglass, graphite or other composite materials. However, it is to be understood that other materials can be used as well, e.g. metal. Saw holder 200 has a top surface 202, bottom surface 204 and body 206. Body 206 includes wall portions 206a and 206b. Saw holder 200 defines a substantially “T” shaped channel 212 that longitudinally extends throughout body 206. Top surface 202 is comprised of portions 208 and 210 that are separated by longitudinally extending channel 212. Channel 212 comprises vertical portion 212a and lateral portions 212b and 212c that are on opposite sides of portion 212a. Channel 212 is sized to receive portion 102a of saw 100 (see FIG. 5C). Channel portion 212a is sized to receive blade 106 of saw 100. Channel portions 212b and 212c are sized to receive edge portions 104a and 104b of saw 100. The formation of channel portions 212b and 212c provides ledges 214 and 216, respectively. When saw 100 is mounted on saw holder 200, portions of bottom surface 105 contact ledges 214 and 216.

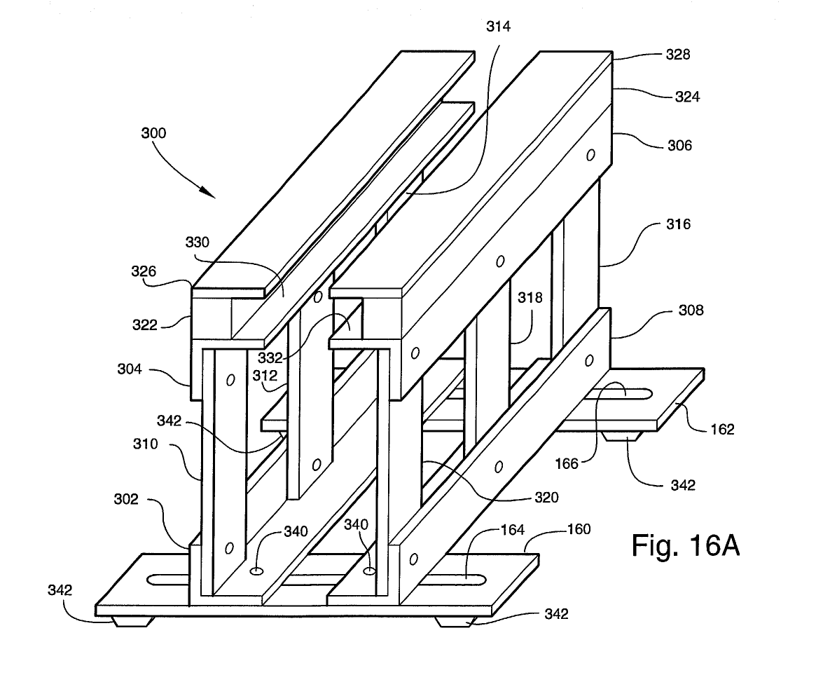

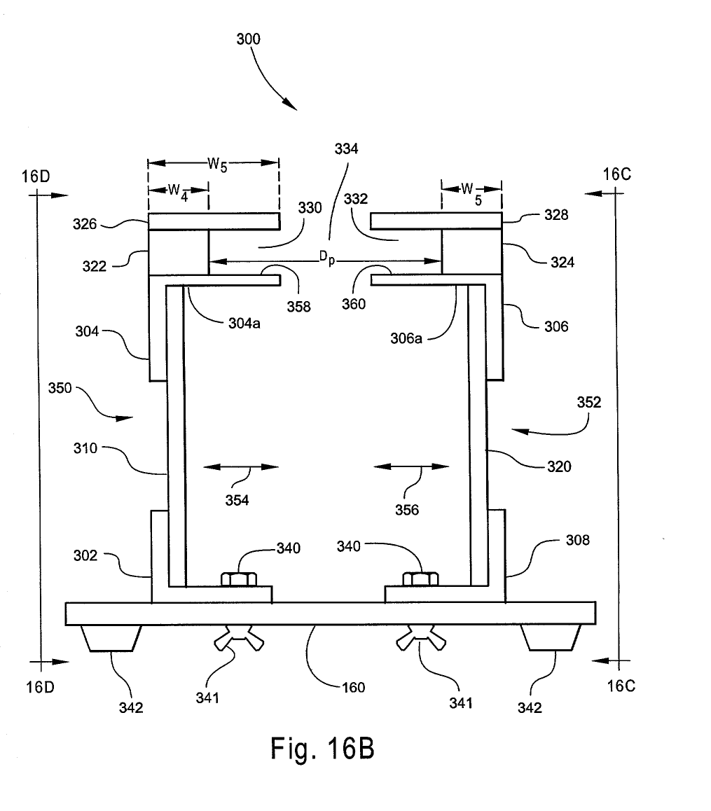

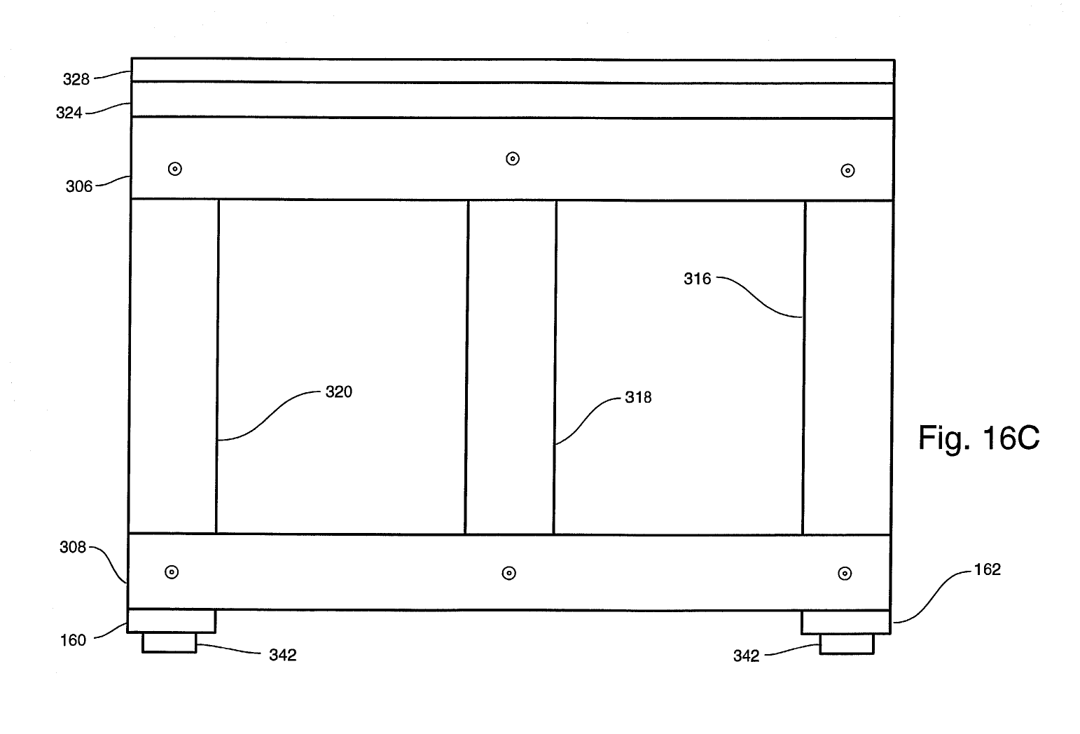

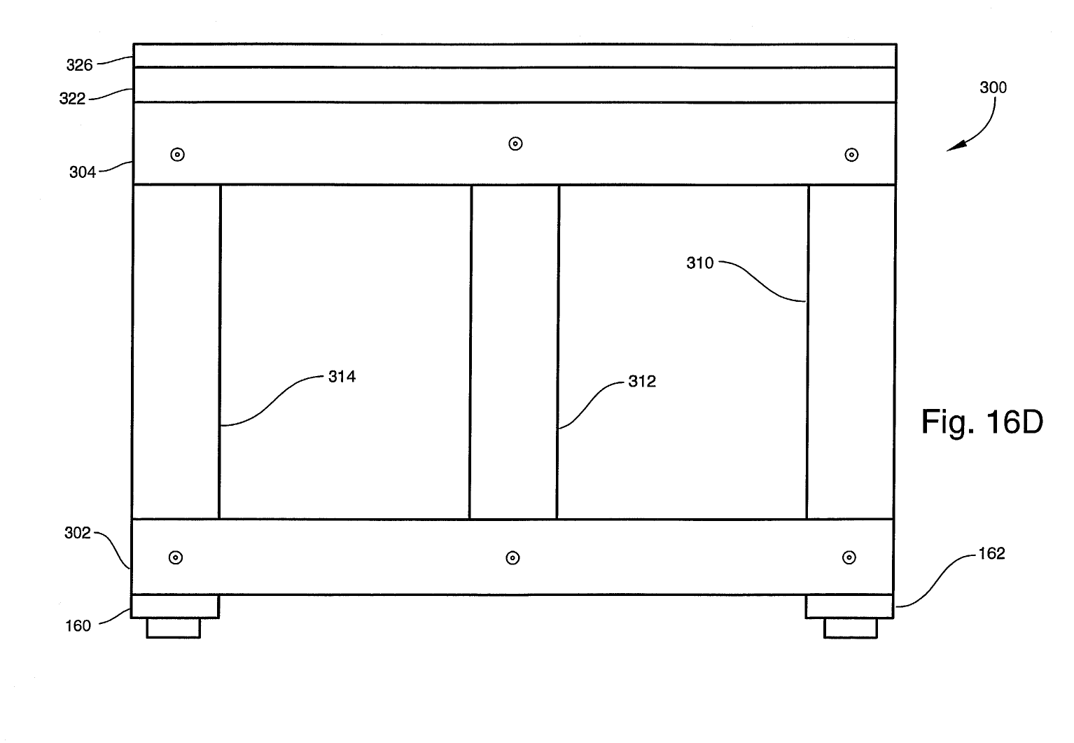

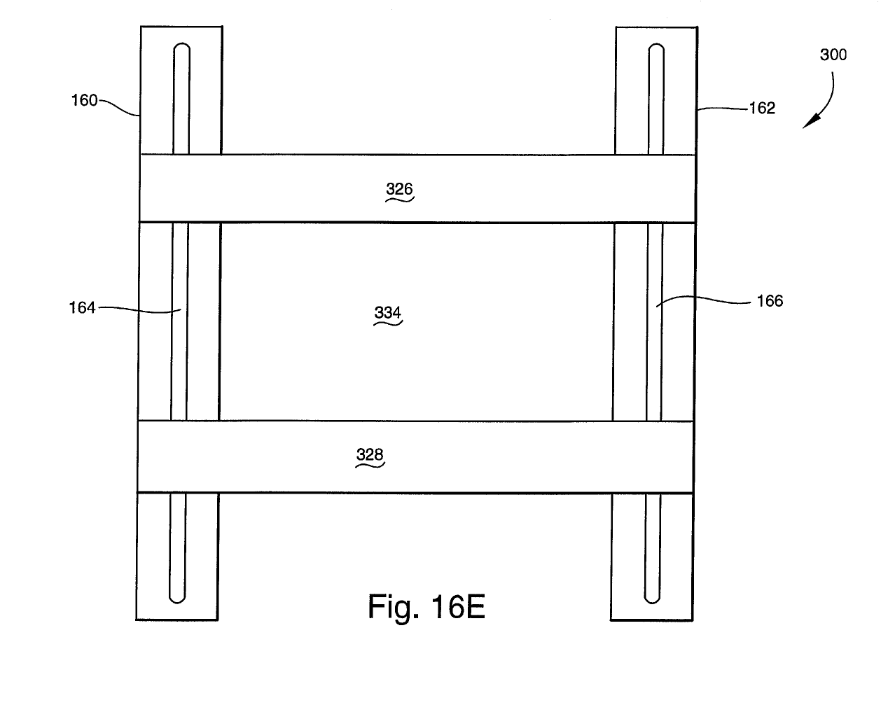

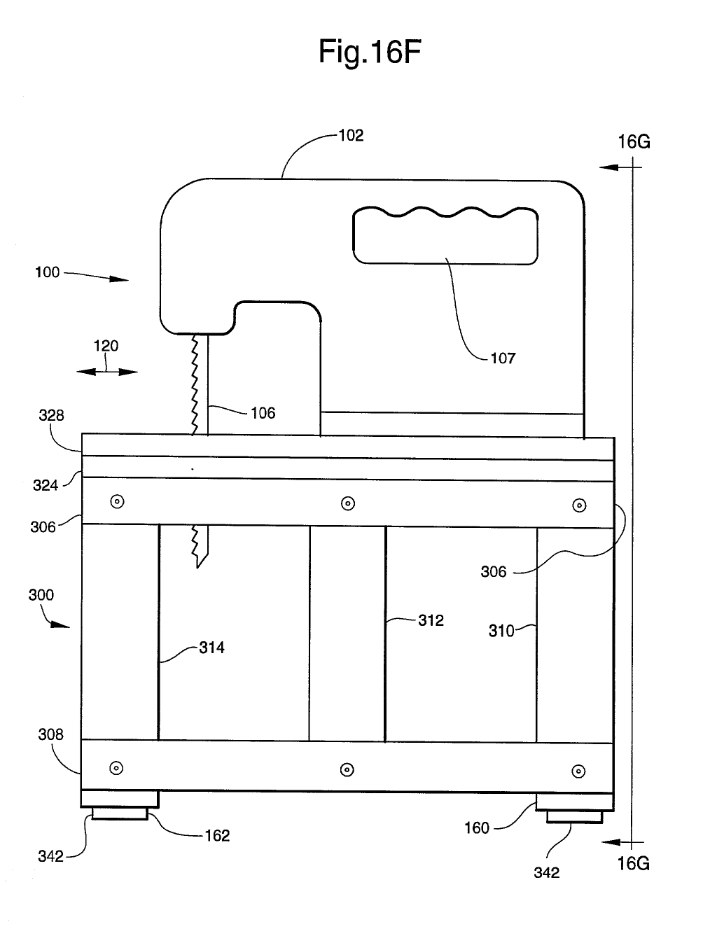

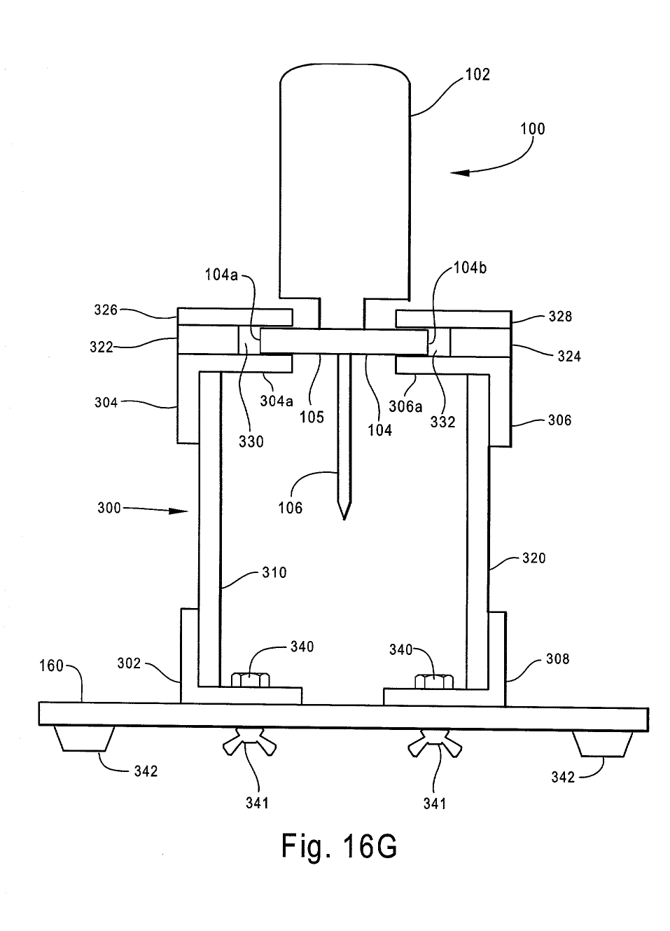

Referring to FIGS. 16A-16G, there is shown another embodiment of the saw holder of the present invention. Saw holder 300 comprises elongate support members 302, 304, 306 and 308. Elongate members 302, 304, 306 and 308 are substantially identical in construction to elongate members 12, 14, 16 and 18, respectively (see FIG. 2). Saw holder 300 further includes vertical members 310, 312 and 314. Members 310, 312 and 314 are attached to and between elongate members 302 and 304. Saw holder 300 further includes members 316, 318 and 320 that are attached to and between elongate members 306 and 308. The manner in which members 310, 312 and 314 are attached to members 302 and 304, and in which members 316, 318 and 320 are attached to members 306 and 308, depend upon the type of materials from which all the aforementioned members are fabricated. For example, if the aforementioned members are fabricated from metal, then screws, rivets, welding or brazing may be used. If these members are fabricated from plastic, then rivets, or ultrasonic welding can be used. Other suitable fastening or attaching techniques can be used. Referring to FIG. 16A, members 310, 312 and 314 are substantially perpendicular to elongate members 302 and 304. Similarly, members 316, 318 and 320 are substantially perpendicular to members 306 and 308.

Referring to FIGS. 16A-D, saw holder 300 further comprises elongate members 322 and 324 that are attached to portions 304a and 306a of members 304 and 306, respectively. The longitudinally extending axes of elongate members 322 and 324 are substantially parallel to the longitudinally extending axes of members 304 and 306, respectively. Each member has a width W4.

Referring to FIGS. 16A-D, saw holder 300 further includes elongate members 326 and 328 that are attached to elongate members 322 and 324, respectively. Each portion 326 and 328 has a width W5 that is greater than width W4. In a preferred embodiment, the width of member 326 is substantially the same as width of portion 304a of member 304. Similarly, the width of member 328 is substantially the same as the width of portion 306a.

Referring to FIG. 16B, portions 304a, and members 322 and 326 define longitudinally extending channel 330. Similarly, portions 306a, members 328 and 324 define longitudinally extending channel 332. The purposes of channels 330 and 332 will be discussed in detail in the ensuing description. As shown in FIG. 16B, portion 304a and members 322, 326 are separated from portion 306a and members 324, 328 by a channel that is generally indicated by numeral 334. The purpose of channel 334 is discussed in the ensuing description.

Saw holder 300 further includes lateral support members 160 and 162 which have been described above (see FIG. 12). Member 160 has a longitudinally extending slot 164. Similarly, member 162 has a longitudinally extending slot 166. Slots 164 and 166 are sized for receiving screws 340 (see FIGS. 16B and 16G). Nuts 341 are threadedly engaged with screws 340. In a preferred embodiment, screws 340 are machine-type screws. In a preferred embodiment, nuts 341 are configured as wing nuts to enable adjustment by hand and without the use of tools. Cleats 342 are attached to the bottom portions of members 160 and 162. Cleats 342 provide clearance for nuts 341. Cleats 342 also prevent saw holder 300 from sliding upon the surface on which saw holder 300 is placed, i.e. floor, counter, workbench, etc. In a preferred embodiment, cleats 342 are made of a material that provides a relatively high coefficient of friction between the cleats 342 and the surface upon which cleats 342 are placed. In a preferred embodiment, cleats 342 are fabricated from rubber.

Referring to FIG. 16B, in order to facilitate understanding of the present invention, members 302, 304, 310, 312, 314, 322 and 326 are collectively referred to as saw holder portion 350 and members 306, 308, 316, 318, 320, 324 and 328 are collectively referred to as saw holder portion 352. The distance Dp refers to the distance between portions 350 and 352. In accordance with the present invention, nuts 341 may be loosened so that portions 350 and 352 may be moved in the direction indicated by arrows 354 and 356, respectively, in order to vary the distance Dp. The purpose of this feature will be discussed below.

Referring to FIGS. 5A, 5B, 5C, 16F and 16G, in order to mount jig saw 100 on saw holder 300, the user first grasps saw 100 and maneuvers saw 100 so that distal ends 112 and 114 of portions 108 and 110, respectively, confront either end of saw holder 300, one of which being shown in FIG. 16B. It does not matter which end of saw holder 300 is used to mount saw 100 thereon since the ends of saw holder 300 are symmetrical in construction. The user then maneuvers saw 100, with respect to saw holder 300, so as to insert distal ends 112 and 114 and edge portions 104a and 104b are inserted into longitudinally extending channels 330 and 332 so that saw 100 is positioned as shown in FIG. 16F. As shown in FIG. 16G, bottom surface 105 of base 104 contacts surfaces 358 and 360 (see FIG. 16B) of portions 304a and 306a, respectively. The user then moves saw 100, relative to saw holder 300, so that substantially all of the longitudinally extending edge portions 104a and 104b of base 104 are positioned between portions 350 and 352 and within longitudinally extending channels 330 and 332 as shown in FIGS. 16F and 16G.

Not every commercially available jig saw will have the same base width W_{B} (see FIG. 5C). In accordance with the present invention, the distance Dp between portions 350 and 352 can be varied in order to accommodate jig saws of varying sizes. Specifically, the user loosens nuts 341 of either or both portions 350 and 352 to allow portions 350 and 352 to be moved in order to increase or decrease the distance Dp in order to allow jig saws having different widths W_{B} to be safely mounted upon saw mount 300. Once the proper distance Dp is determined, nuts 341 may be tightened to prevent movement of portions 350 and 352.

In a preferred embodiment, indicia is placed on lateral extending support members 160 and 162 to facilitate precise alignment of portions 350 and 352 and to facilitate correct positioning of portions 350 and 352 when it is necessary to vary the distance Dp.

Saw holder 300 can be fabricated from a variety of materials such as wood, metal, plastic, rubber, graphite or fiberglass. Other suitable materials may also be used.

In an alternate embodiment, vertical support members 310, 314, 316 and 320 are not used. In such a configuration, only vertical members 312 and 318 are used to support members 304, 322, 326 and 306, 324 and 328, respectively.

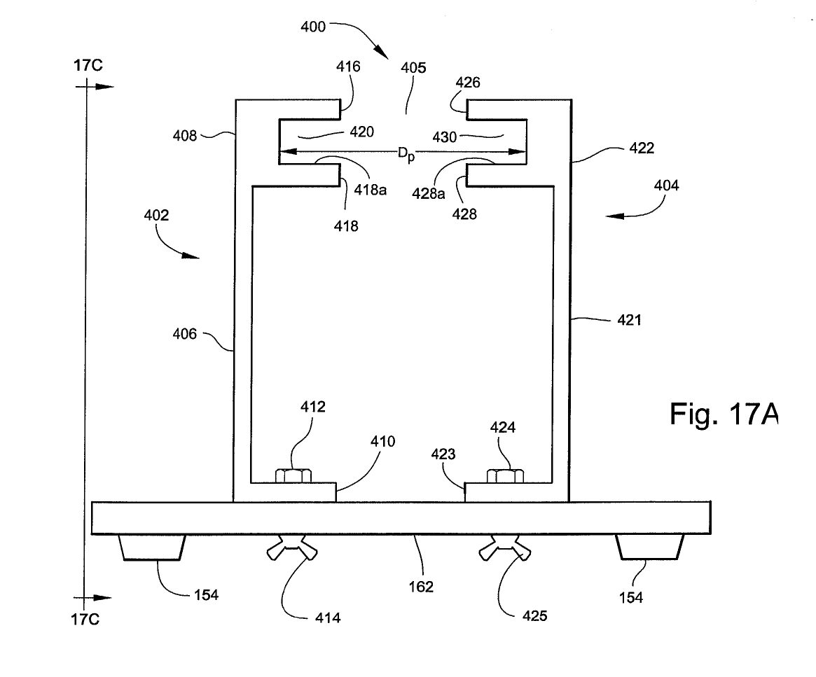

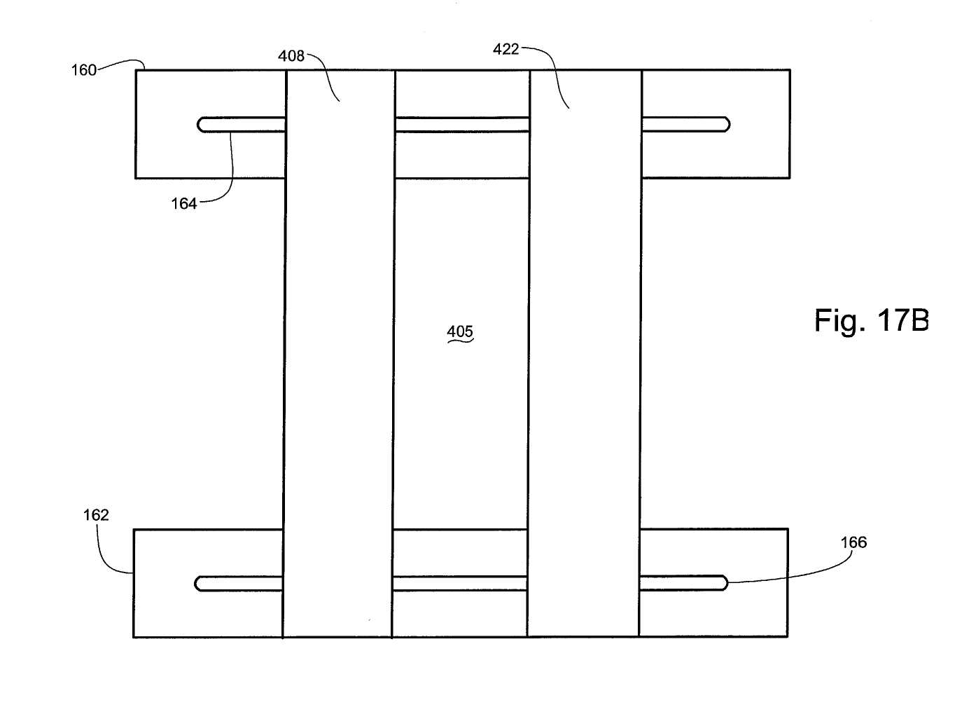

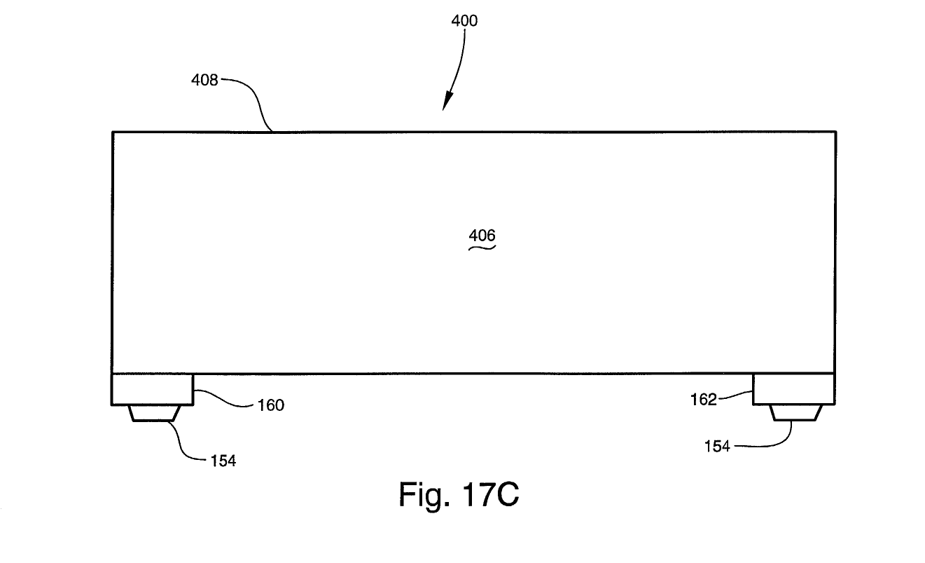

Referring to FIGS. 17A-C, there is shown another embodiment of the present invention. Saw holder 400 of the present invention. Saw holder 400 generally comprises portions 402, 404 and lateral members 160 and 162. Members 160 and 162 were previously described above (see FIG. 12). Portions 402 and 404 are substantially identical in construction to each other. Portions 402 and 404 are separated by a longitudinally extending channel generally indicated by numeral 405. Portion 402 comprises generally vertical wall portion 406, top portion 408 and bottom portion 410. Top portion 408 and bottom portion 410 are attached to generally vertical wall portion 406. Bottom portion 410 is angulated with respect to wall portion 406. In a preferred embodiment, bottom portion 410 is substantially perpendicular to wall portion 406. Bottom portion 410 includes a bore there through (not shown) for receiving screw 412. Nut 414 is threadedly engaged to screw 412. In one embodiment, screw 412 is configured as a machine screw and nut 414 is a configured as a wing nut. Upper portion 408 defines laterally extending portions 416 and 418. Portions 416 and 418 define a longitudinally extending channel 420.

Similarly, portion 404 comprises generally vertical wall portion 421, top portion 422 and bottom portion 423. Top portion 422 and bottom portion 423 are attached to wall portion 421. Bottom portion 423 is angulated with respect to wall portion 421. In a preferred embodiment, bottom portion 423 is substantially perpendicular to wall portion 421. Bottom portion 423 includes a bore there through (not shown) for receiving screw 424. Nut 425 is threadedly engaged to screw 424. In one embodiment, screw 424 is configured as a machine screw and nut 425 is configured as a wing nut. Upper portion 422 defines laterally extending portions 426 and 428. Portions 426 and 428 define a longitudinally extending channel 430. The purpose of channels 420 and 430 is the same as that of channels 62 and 64, respectively, shown in FIG. 2 and that of channels 330 and 332, respectively, shown in FIG. 16B. Thus, channels 420 and 430 receive edge portions 104a and 104b of bottom portion 104 of saw 100. Portions of bottom surface 105 of saw bottom portion 104 contact surfaces 418a and 428a of portions 418 and 428, respectively.

In accordance with the present invention, the distance Dp between portions 402 and 404 can be varied in order to accommodate jig saws of varying sizes. In accordance with the present invention, the user loosens nut 414 and/or nut 425 so as to allow movement of portion 402 and/or portion 404. Thus, portions 402 and 404 can be moved in order to increase or decrease the distance Dp in order to allow jig saws having different widths W_{B} (see FIG. 5C) to be safely mounted upon saw mount 400. Once the proper distance Dp is determined, nut 414 and/or nut 425 may be tightened so as to prevent movement of portions 402 and 404.

In an alternate embodiment, vertical wall portion 406 has cut-outs or openings in the area between top portion 408 and bottom portion 410, and vertical wall portion 421 has cut-outs or openings in the area between top portion 422 and bottom portion 423. Such openings reduce the amount of material from which the wall portions 406 and 421 are made thereby reducing weight and the per-unit cost of saw holder 400.

Saw holder 400 can be fabricated from a variety of materials such as wood, metal, plastic, rubber, graphite or fiberglass. Other suitable materials may also be used. In one embodiment, portions 402 and 404 may be fabricated from plastic by an injection molding process.

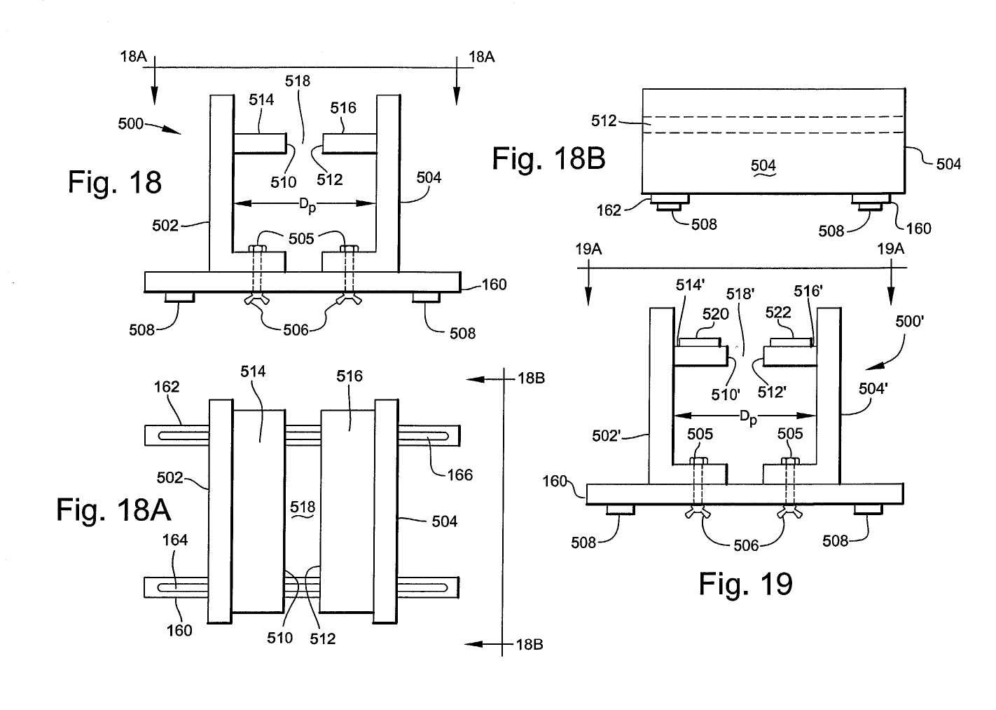

Referring to FIGS. 18, 18A and 18B, there is shown an alternate embodiment of the saw holder of the present invention. Saw holder 500 comprises upstanding wall members 502 and 504. Wall members 502 and 504 are movably attached to lateral support members 160 and 162. Members 160 and 162 were previously described in the foregoing description (see FIGS. 12 and 16E). Screws 505 are sized to be inserted through slots 164 and 166. Screws 505 and wing nuts 506 allow wall members 502 and 504 to be laterally moved to vary the distance Dp between wall members 502 and 504 in order to accommodate jig saws of different sizes. Cleats 508 are attached to the lateral support members 160 and 162 and function in the same manner as cleats 342 discussed above (see FIGS. 16A and 16F). Wall member 502 includes lip 510. As shown in FIG. 18A, lip 510 longitudinally extends for substantially the entire length of wall member 502. In one embodiment, lip 510 is generally perpendicular to wall member 502 (see FIG. 18). Similarly, wall member 504 includes lip 512. As shown in FIG. 18A, lip 512 longitudinally extends for substantially the entire length of wall member 504. In one embodiment, lip 512 is generally perpendicular to wall member 504. FIG. 18B shows lip 512 in phantom. Lips 510 and 512 have surfaces 514 and 516, respectively, for receiving portions of bottom surface 105 of saw base portion 104 (see FIG. 5C). Longitudinally extending channel 518 is located between lips 514 and 516. Channel 518 receives blade 106 of saw 100. In order to mount saw 100 on saw holder 500, the user positions saw 100 so that blade 106 is disposed within channel 518 and portions of bottom surface 105 of saw base 104 rest upon surfaces 514 and 516.

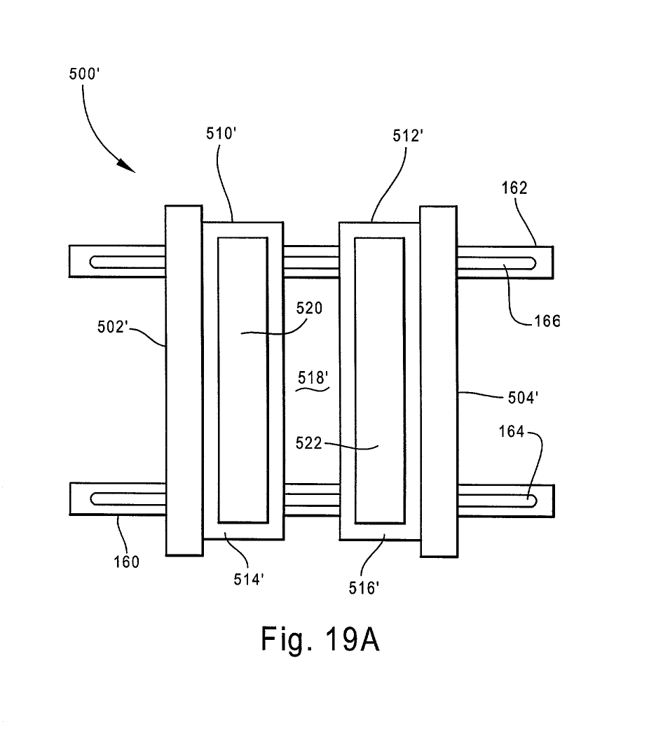

FIG. 19 is an end view of an alternate embodiment of saw holder 500. Saw holder 500′ comprises wall members 502′ and 504′ which are generally the same in construction as wall members 502 and 504, respectively, of saw holder 500. Wall members 502′ and 504′ are movably attached to lateral support members 160 and 162 via screws 505′ and wing nuts 506′. Thus, a user may loosen wing nuts 506′ in order to laterally move wall members 502′ and 504′ to vary the distance D_{P} between wall members 502′ and 504′ in order to accommodate saws of varying sizes. Wall member 502′ includes lip 510′. Lip 510′ longitudinally extends for substantially the entire length of wall member 502′. In one embodiment, lip 510′ is generally perpendicular to wall member 502′. Similarly, wall member 504′ includes lip 512′. Lip 512′ longitudinally extends for substantially the entire length of wall member 504′. In one embodiment, lip 512′ is generally perpendicular to wall member 504′. Longitudinally extending channel 518′ is located between lips 510′ and 512′ and receives blade 106 of saw 100.

Referring to FIG. 19A, lip 510′ has a surface 514′ and a permanent magnet 520 that is attached to surface 514′. Magnet 520 longitudinally extends along surface 514′. Similarly, lip 512′ has surface 516′ and permanent magnet 522. Magnet 522 longitudinally extends along surface 516′. In order to mount saw 100 on saw holder 500′, the user positions saw 100 so that blade 106 is disposed within channel 518′ and portions of bottom surface 105 of saw base 104 are magnetically attached to magnets 520 and 522. In order to remove saw 100 from mount 500′, the user must pull saw 100 upward with a force that sufficient to break the magnetic bond between base 104 of saw 100 and magnets 520 and 522.

Magnets 520 and 522 may be attached to surfaces 514′ and 516′ by any suitable method, e.g. screws, brackets, clamps, etc.

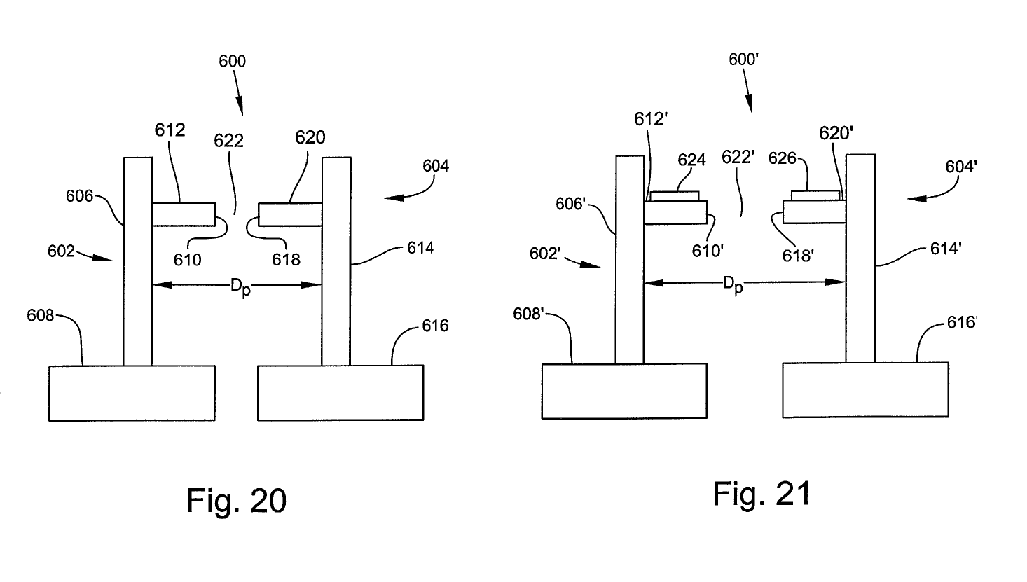

Referring to FIGS. 20, 21 and 22, there are shown end views of further embodiments of the saw holder of the present invention. However, each of these embodiments are configured as two separate pieces or sections. Referring to FIG. 20, saw holder 600 comprises sections 602 and 604. Section 602 comprises wall member 606 and base 608. Wall member 606 is attached to base 608 and is generally the same in shape and structure as wall member 502 (see FIG. 18). Wall member 606 includes lip 610 that is generally the same in shape and structure as lip 510 (see FIG. 18). Lip 610 includes surface 612. Lip 610 and surface 612 have the same purpose and function in the same manner as lip 510 and surface 514, respectively (see FIG. 18). Base 608 longitudinally extends for substantially the entire length of wall member 606. In one embodiment, base 608 is configured to have significant weight (“weighted”) to provide stability. In such a configuration, it is preferred that base 608 have a total weight between about 0.5 pounds and 3.0 pounds, inclusive.

Similarly, section 604 comprises wall member 614 and base 616. Wall member 614 is attached to base 616 and is generally the same in shape and construction as wall member 504 (see FIG. 18). Wall member 614 has lip 618. Lip 618 has surface 620. Lip 618 and surface 620 have the same purpose and function in the same manner as lip 512 and surface 516, respectively (see FIG. 18). In one embodiment, base 616 is configured to have a significant weight (“weighted”) to provide stability. In such a configuration, it is preferred that base 616 have a total weight between about 0.5 pounds and 3.0 pounds, inclusive. If bases 608 and 616 are to be configured to be weighted, then it is preferred that bases 608 and 616 be fabricated from heavy metals such as steel, iron, cast iron, lead, etc. However, other suitable materials that provide sufficient weight to provide stability may be used. If bases 608 and 616 are not configured to be “weighted”, then other materials may be used to fabricate section 602 and 604, e.g. plastic, wood, graphite, light metals, etc.

Referring to FIG. 20, longitudinally extending channel 622 is located between lips 610 and 618 and has the same purpose as channel 518 (see FIG. 18). Sections 602 and 604 can be laterally moved to vary the distance D_{P} to accommodate saws of varying size.

Referring to FIG. 21, there is shown a further embodiment of the saw holder of the present invention. Saw holder 600′ comprises sections 602′ and 604′. Section 602′ is generally the same in shape and construction as section 602 (see FIG. 20). Section 602′ comprises wall member 606′ and base 608′. Wall member 606′ and base 608′ have the same shape and structure as wall member 606 and base 608, respectively (see FIG. 20). Wall member 606′ and base 608′ have the same purpose and function in the same manner as wall member 606 and base 608, respectively (see FIG. 20). Wall member 606′ includes lip 610′. Lip 610′ has surface 612′. Lip 610′ and surface 612′ are generally the same in shape and structure as lip 610 and surface 612, respectively (see FIG. 20). Section 602′ further includes permanent magnet 624. Magnet 624 is generally the same in shape and structure as magnet 520 (see FIG. 19). Magnet 624 has the same purpose and functions in the same manner as magnet 520.

Referring to FIG. 21, section 604′ is generally the same in shape and construction as section 604 (see FIG. 20). Section 604′ comprises wall member 614′ and base 616′. Wall member 614′ and base 616′ have the same shape and structure as wall member 614 and base 616, respectively (see FIG. 20). Wall member 614′ and base 616′ have the same purpose and function in the same manner as wall member 614 and base 616, respectively (see FIG. 20). Wall member 614′ includes lip 618′. Lip 618′ has surface 620′. Lip 618′ and surface 620′ are generally the same in shape and structure as lip 618 and surface 620, respectively (see FIG. 20). Section 604′ further includes permanent magnet 626. Magnet 626 is generally the same in shape and structure as magnet 522 (see FIG. 19). Magnet 626 has the same purpose and functions in the same manner as magnet 522 (see FIG. 20). Longitudinally extending channel 622′ is located between lips 610′ and 618′ and has the same purpose as channel 622 (see FIG. 20). Bases 608′ and 616′ have the same (i) purpose, (ii) shape and (iii) structure as bases 608 and 616, respectively (see FIG. 20).

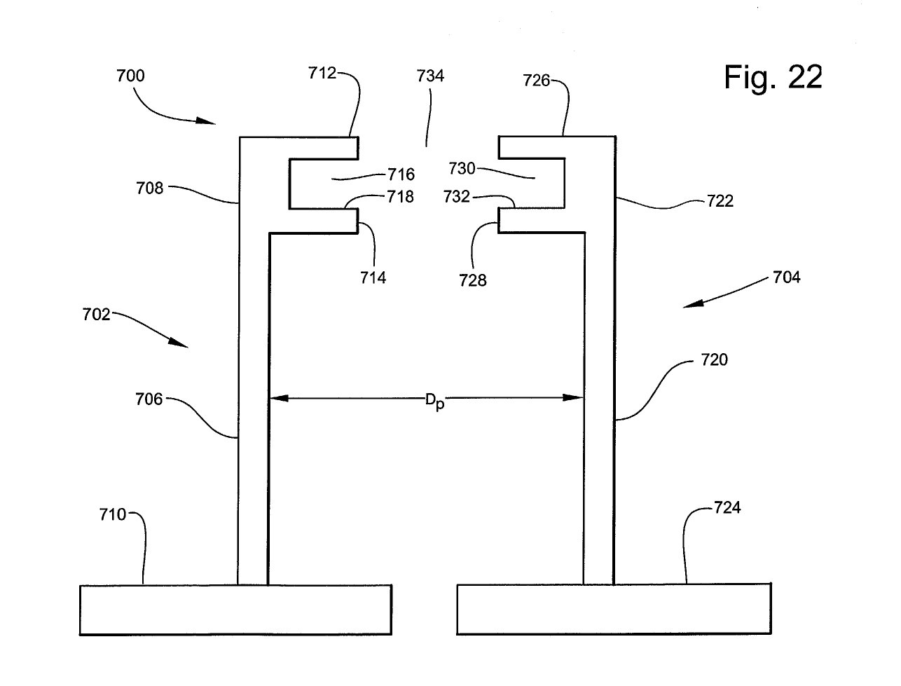

Referring to FIG. 22, there is shown a further embodiment of the saw holder of the present invention. Saw holder 700 comprises sections 702 and 704. Section 702 comprises wall member 706, upper portion 708 and base portion 710. Upper portion 708 and base portion 710 are attached to wall member 706. Wall member 706 is generally the same in construction as wall member 406 (see FIG. 17A). Upper portion 708 has generally the same shape and construction as upper portion 408 (see FIG. 17A). Upper portion 708 includes portions 712 and 714 that longitudinally extend for substantially the entire length of wall member 706. In a preferred embodiment, portions 712 and 714 are generally perpendicular with respect to wall member 706. Portions 712 and 714 define longitudinally extending channel 716. Portions 712, 714 and channel 716 have the same shape and function as portions 416, 418 and channel 420, respectively, of saw holder 400 (see FIG. 17A).

Referring to FIG. 22, section 704 comprises wall member 720, upper portion 722 and base portion 724. Wall member 720 is generally the same in construction as wall member 421 (see FIG. 17A). Upper portion 722 has generally the same shape and construction as upper portion 422 (shown in FIG. 17A). Upper portion 722 includes portions 726 and 728 that longitudinally extend for substantially the entire length of wall member 720. Portions 726 and 728 are generally perpendicular with respect to wall member 720. Portions 726 and 728 define longitudinally extending channel 730. Portions 726, 728 and channel 730 have the same shape and function as portions 426, 428 and channel 430, respectively, of saw holder 400 (see FIG. 17A). As shown in FIG. 22, longitudinally extending channel 734 is located between upper portions 708 and 722 and receives blade 106 of saw 100.

Base 710 longitudinally extends for substantially the entire length of wall member 706. Similarly, base portion 724 longitudinally extends for substantially the entire length of wall member 720. Base portions 710 and 724 have the same function and generally the same shape as base portions 608 and 616, respectively (see FIG. 20). Sections 702 and 704 can be moved laterally to vary the distance D_{P} in order to accommodate jig saws of varying sizes.

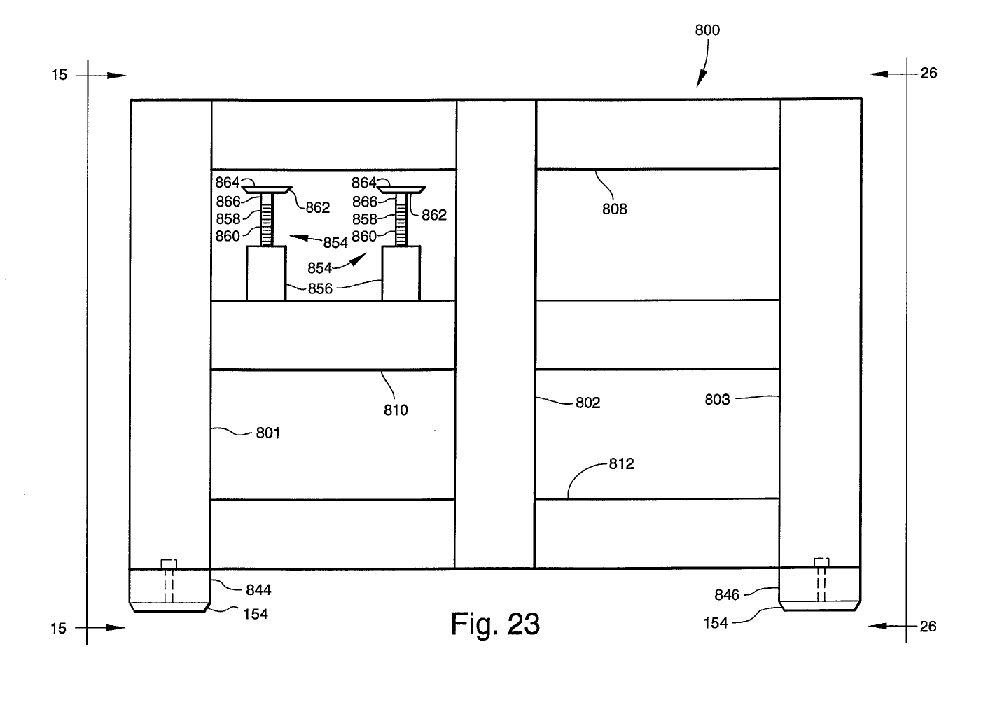

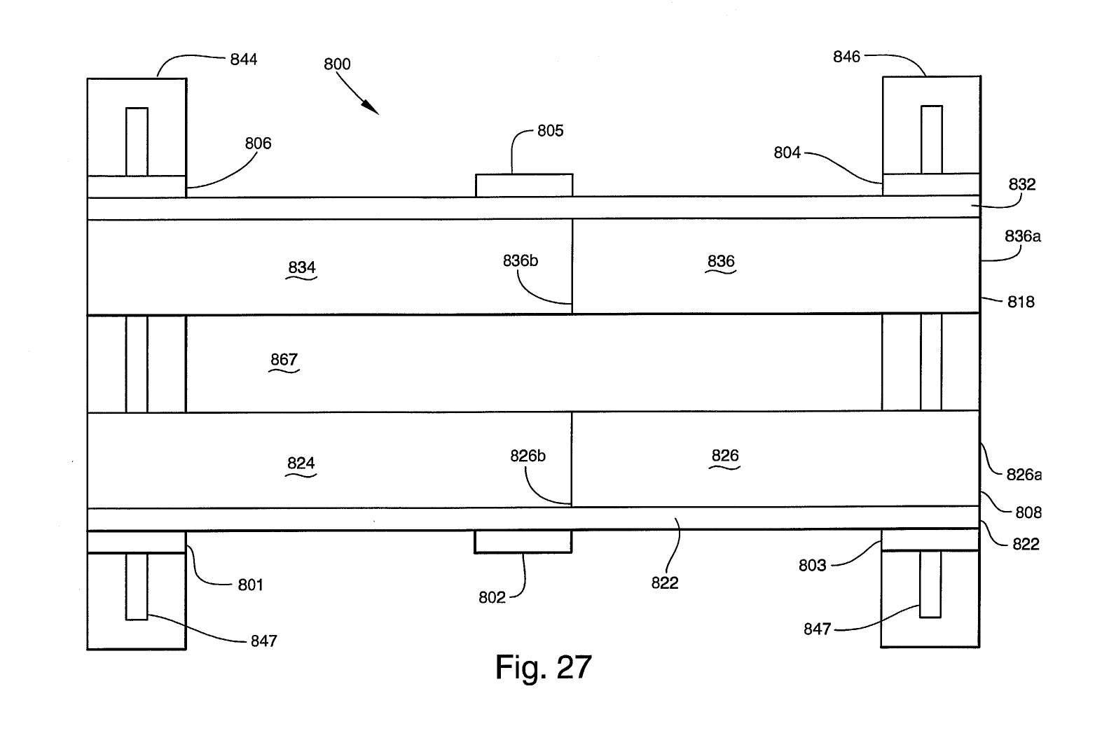

In another embodiment, the saw holder of the present invention includes structural features that allow the saw holder to also be used to retain and secure a work piece, e.g. wood, plastic, metal, etc. to enable a user to cut that work piece with saw 100. This embodiment, is shown in FIGS. 23-31. Saw holder 800 generally comprises generally vertical or upstanding members 801, 802, 803, 804, 805 and 806, and elongated support members 808, 810, 812, 814, 816 and 818. Elongate support members 808, 810 and 812 are attached to generally upstanding members 801, 802 and 803. Similarly, elongated support members 814, 816 and 818 are attached to generally upstanding members 804, 805 and 806. Members 812 and 814 are generally the same in construction as members 16 and 18, respectively, which were described in the foregoing description (see FIG. 2). Members 810 and 816 are generally the same in construction as members 14 and 12, respectively (see FIG. 2). Elongate members 808, 810, 812, 814, 816 and 818 each have a longitudinally extending axis. Members 801, 802, 803, 804, 805 and 806 may be attached to elongated support members 808, 810, 812, 814, 816 and 818 by any suitable method depending upon the materials from which saw holder 800 is fabricated. For example, if saw holder 800 is fabricated from metal, then screws, rivets, welding, etc. can be used to attach members 801, 802, 803, 804, 805 and 806 to elongated support members 808, 810, 812, 814, 816 and 818. In another example, if saw holder 800 is fabricated from plastic, then screws, rivets, or ultrasonic welding can be used to attach members 801, 802, 803, 804, 805 and 806 to elongated support members 808, 810, 812, 814, 816 and 818.

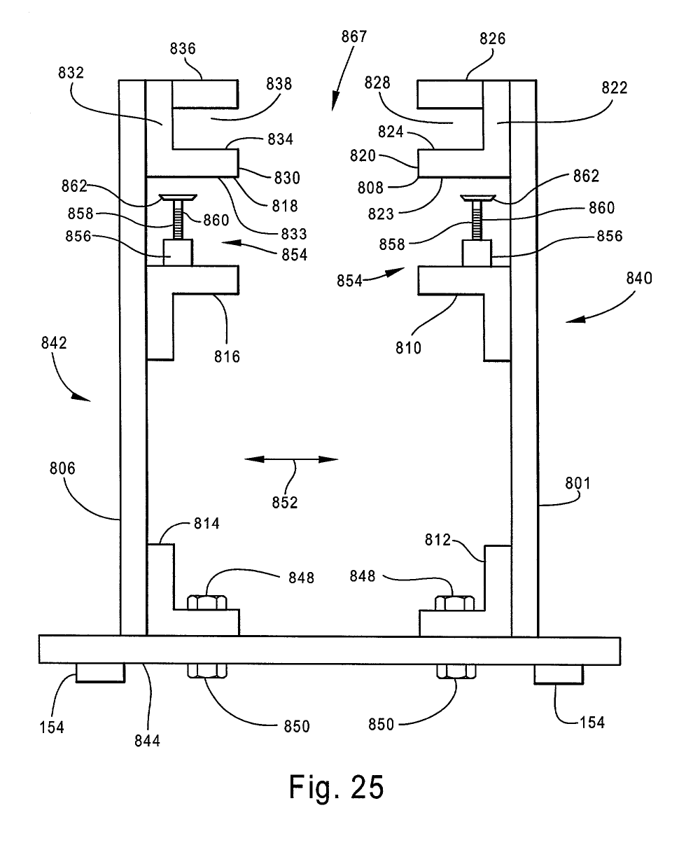

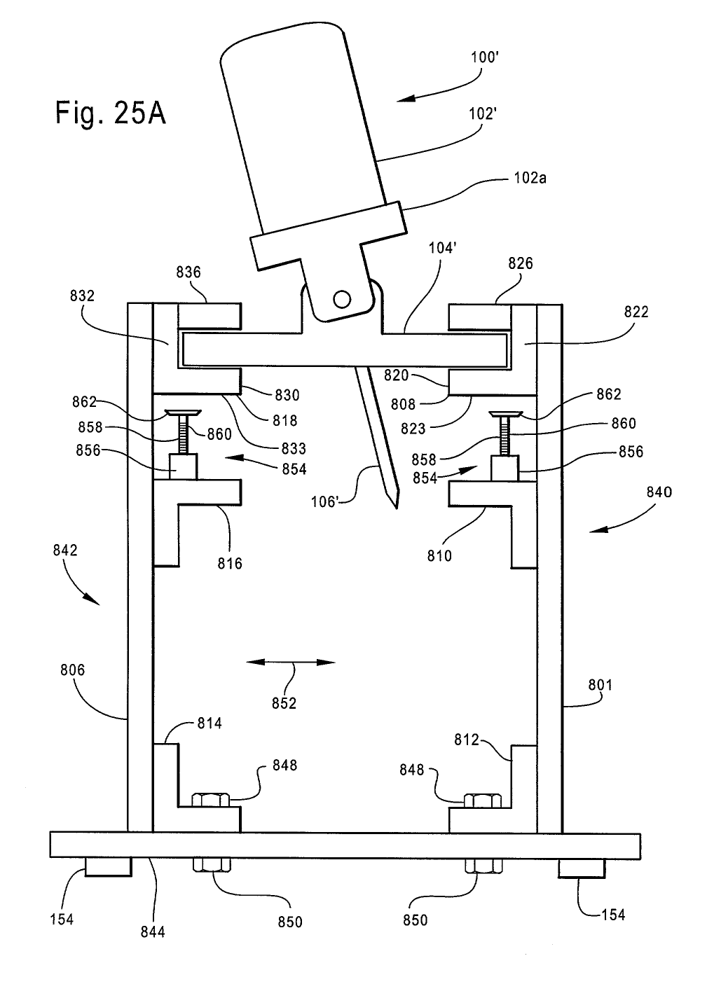

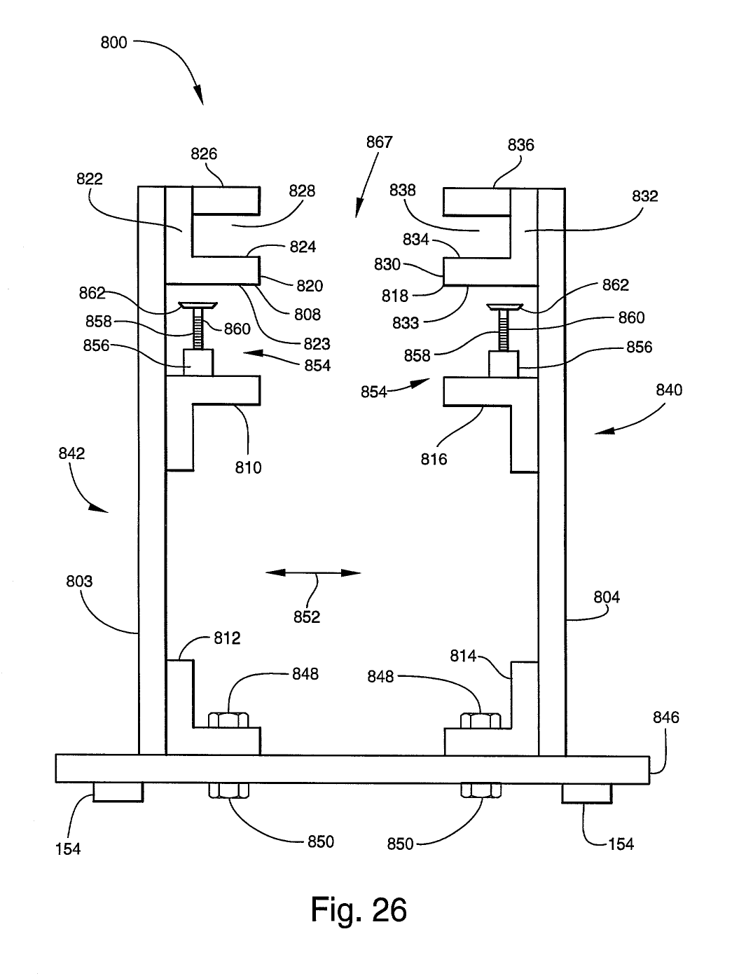

Referring to FIGS. 25 and 26, member 808 generally comprise a longitudinally extending bottom portion 820 and a generally vertical and longitudinally extending wall portion 822 that is attached to bottom portion 820. Bottom portion 820 has bottom surface 823 and top surface 824. Referring to FIGS. 25, 26 and 27, member 808 further comprises top portion 826. Top portion 826 has ends 826a and 826b and longitudinally extends for a predetermined distance. Top portion 826 has a length that is less than the length of bottom and wall portions 808 and 822, respectively. Thus, portion 826 extends over only a portion of surface 824. In one embodiment, portion 826 extends over about half of surface 824. Referring to FIGS. 25 and 26, bottom portion 808, wall portion 822 and top portion 826 cooperate to define channel 828 that is sized for receiving a portion of bottom portion 104 of saw 100. A portion of bottom surface 105 of saw bottom portion 104 contacts surface 824.

Referring to FIGS. 25 and 26, member 818 generally comprises a longitudinally extending bottom portion 830 and a generally vertical and longitudinally extending wall portion 832 that is attached to bottom portion 830. Bottom portion 830 has bottom surface 833 and top surface 834. Referring to FIGS. 25, 26 and 27, member 818 further comprises top portion 836 that has end 836a and 836b and longitudinally extends for a predetermined distance. Top portion 836 has a length that is less than the length of bottom and wall portions 830 and 832, respectively. Thus, portion 836 extends over only a portion of surface 834. In one embodiment, portion 836 extends over about half of surface 834. Referring to FIGS. 25 and 26, bottom portion 830, wall portion 832 and top portion 836 cooperate to define channel 838 that is sized for receiving a portion of bottom portion 104 of saw 100. A portion of bottom surface 105 of saw bottom portion 104 contacts surface 834.

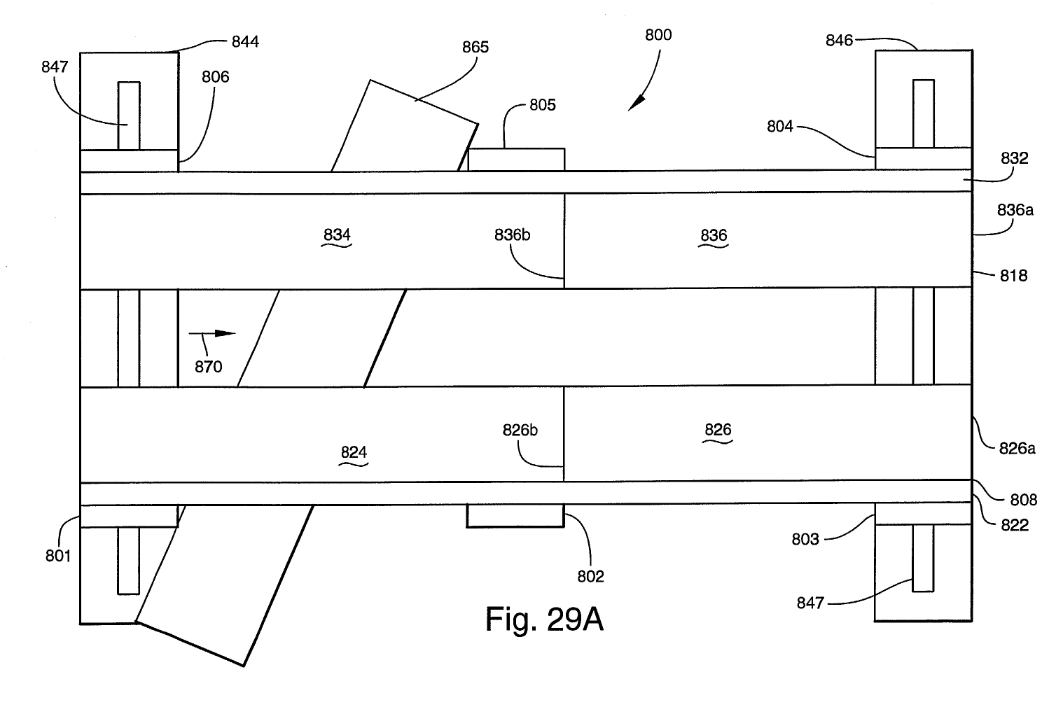

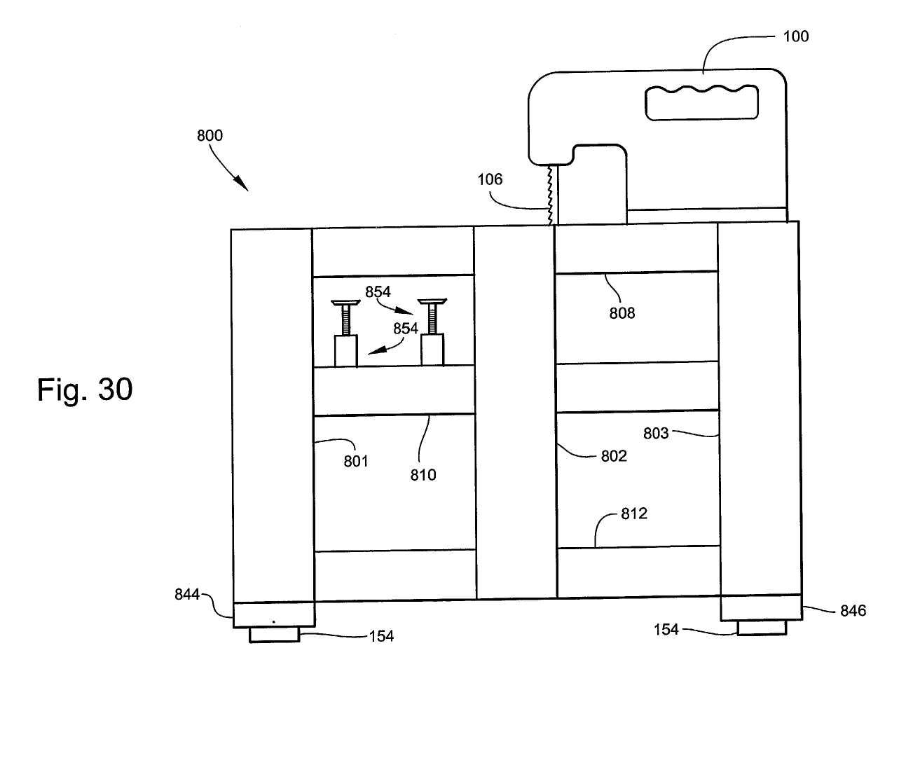

Thus, when saw 100 is mounted on holder 800, as shown in FIG. 30, portions of saw bottom portion 104 are positioned within channels 828 and 838 in a manner similar to the way the same portions of saw bottom portion 104 are inserted into channels 62 and 64 shown in FIG. 7.

With such a configuration, saw holder 800 is separated into two saw holder portions wherein one portion comprises members 801, 802, 803, 808, 810 and 812, generally indicated by the numeral 840, and the other portion comprises members 804, 805, 806, 814, 816 and 818, which is generally indicated by numeral 842. Referring to FIGS. 23-28, saw holder 800 further includes lateral support members 844 and 846 which are substantially identical to lateral support members 160 and 162, respectively, which were described above. Members 844 and 846 each have a longitudinally extending slot 847. Saw holder portions 840 and 842 are removably attached to lateral support members 844 and 846. In one embodiment, screws 848 are disposed through slots 847 on lateral support members 844 and 846 and threadedly engaged with nuts 850. In a preferred embodiment, nuts 850 are configured as wing nuts. When nuts 850 are loosened, saw holder portions 840 and 842 can be moved laterally, as indicated by arrows 852 (see FIGS. 25 and 26), to vary the distance between saw holder portions 840 and 842 in order to accommodate jig saws of varying widths W_{B} (see FIG. 5C).

In one embodiment, elongate support members 844 and 846 have indicia thereon representing various widths of jig saws to facilitate the appropriate placement of saw holder portions 840 and 842 upon members 844 and 846.

Referring to FIGS. 23-25, 28 and 29, saw holder 800 further comprises clamping devices 854 that are attached to elongate support members 810 and 816. Although two clamping devices are shown, it is to be understood that more or less than two clamping devices 854 can be used. Each clamping device 854 comprises mount 856 and contact member 858 that is movably attached to mount 856. Mount 856 has a threaded inlet (not shown). In one embodiment, contact member 858 has a threaded stem 860 and generally flat head 862 attached to stem 860. Stem 860 is threadedly engaged in the threaded inlet of mount 856. Head 862 has a substantially flat surface 864 for contacting work piece 865. Stem 860 can be rotated in a first direction so that head 862 moves toward bottom surfaces 823 and 833 of members 808 and 818, respectively, and in a second direction so that head 862 moves away from bottom surfaces 823 and 833 of members 808 and 818, respectively. In one embodiment, each stem 860 has portion 866 that is configured to be grasped with a wrench so as to facilitate rotation of contact member 858. In another embodiment, each stem 860 has a small handle (not shown) attached thereto to facilitate rotation of contact member 858.

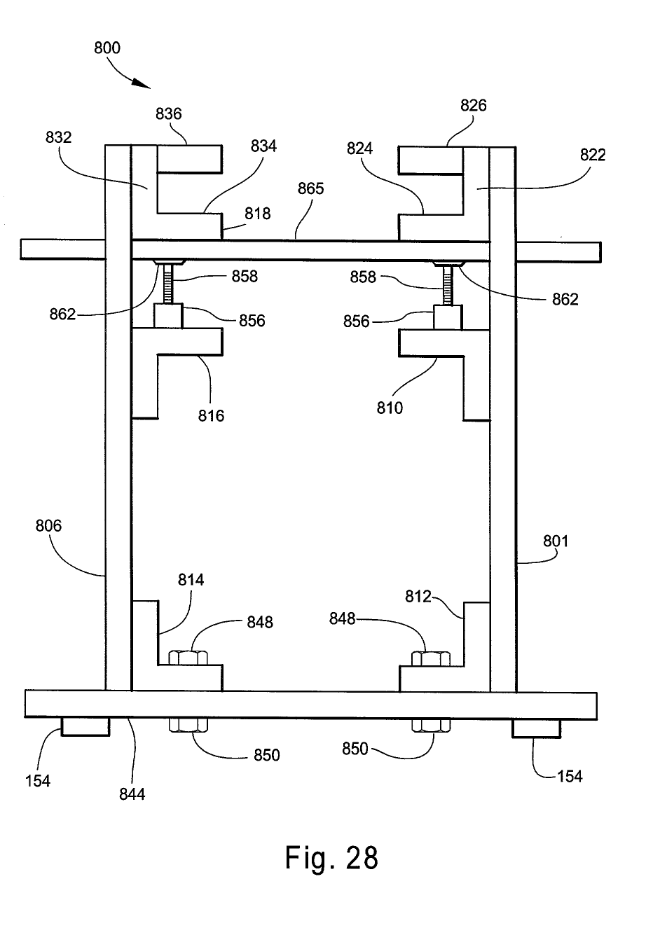

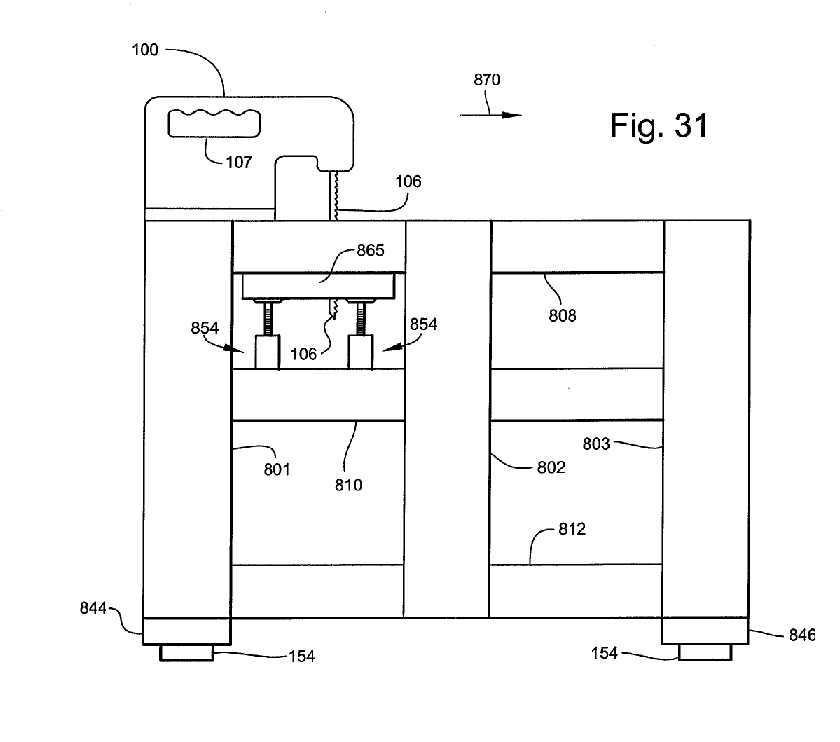

Referring to FIGS. 28, 29 and 31, stems 860 can be rotated in the second direction so as to allow work piece 865 (e.g. wood, plastic, metal, etc.) to be inserted between head 862 of each clamping device 854 and bottom surfaces 823 and 833. Stem 860 is then rotated in the first direction so as to allow head 862 to press work piece 865 against surfaces 823 and 833 in order to secure the work piece. In order to cut the work piece, jig saw 100 is positioned such that portions of the bottom surface 105 of saw bottom portion 104 contact surfaces 824 and 834 of members 808 and 818, respectively, and blade 106 is disposed in the space or channel 867 that is between members 808 and 818. Jig saw 100 is then activated and moved in the direction indicated by arrow 870 to effect cutting of work piece 865 (see FIG. 31). Once work piece 865 is cut, jig saw 100 is removed from surfaces 824 and 834 and mounted on the other end of saw holder 800, as shown in FIG. 30, such that portions of the saw bottom portion 104 are within channels 828 and 838 as described above. Stems 860 are the rotated in the second direction to allow the now separated portions of work piece 865 to be removed.

Since top portions 826 and 836 only partially extend over surfaces 824 and 834, respectively, portions 826 and 836 do not interfere with saw 100 as it cuts work piece 865. If screws or rivets are used to attach members 801, 802, 803, 804, 805 and 806 to elongated support members 808, 810, 812, 814, 816 and 818, then such screws should be sized and positioned so as not to interfere with (i) saw 100 as it moves along surfaces 824 and 834, or (ii) the portions of saw bottom portion 104 that are within channels 828 and 838.

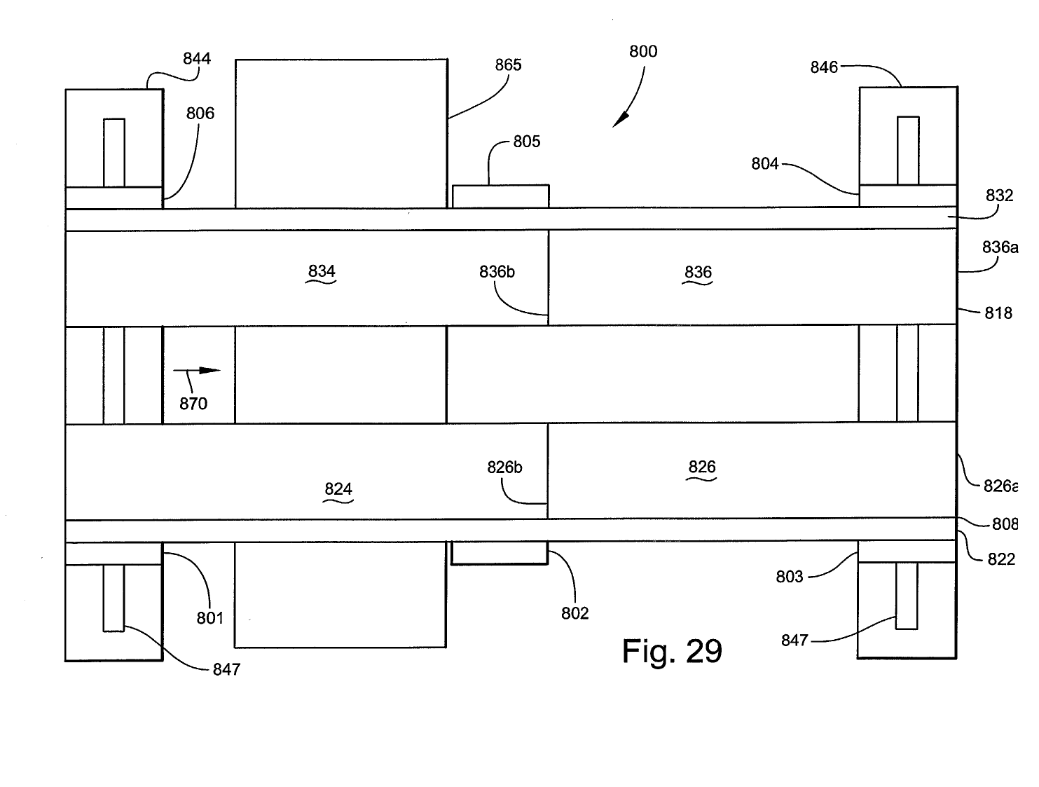

If it is desired to effect a cross-cut of work piece 865 such that the cut that is to be made by jig saw 100 is to be substantially square or perpendicular to the longitudinal axis of the work piece, then work piece 865 is positioned in a manner such that it abuts upstanding members 802 and 805 to prevent movement of work piece 865 and to ensure that the longitudinal axis of work piece 865 is substantially perpendicular to the axes of elongate members 808 and 818. However, it is to be understood that work piece 865 can be position in other orientations to allow cuts of varying angles to be made. For example, the work piece can be positioned as shown in FIG. 29A in order to allow the work piece to be cut at an angle.

Saw holder 800, and all the other embodiments of the saw holder of the present invention which have been described in the foregoing description, can also accommodate jig saws that have adjustable angle base plates which allow the body of the jig saw to pivot with respect to the base in order to make angled cuts. This is illustrated in FIG. 25A. Saw 100′ comprises body 102′, body bottom portion 102a′, base 104′ and blade 106′. Body bottom portion 102a′′is pivotally attached to base 104′ such that body 102′ can pivot or tilt so as to orient blade 106′ to a desired angular orientation.

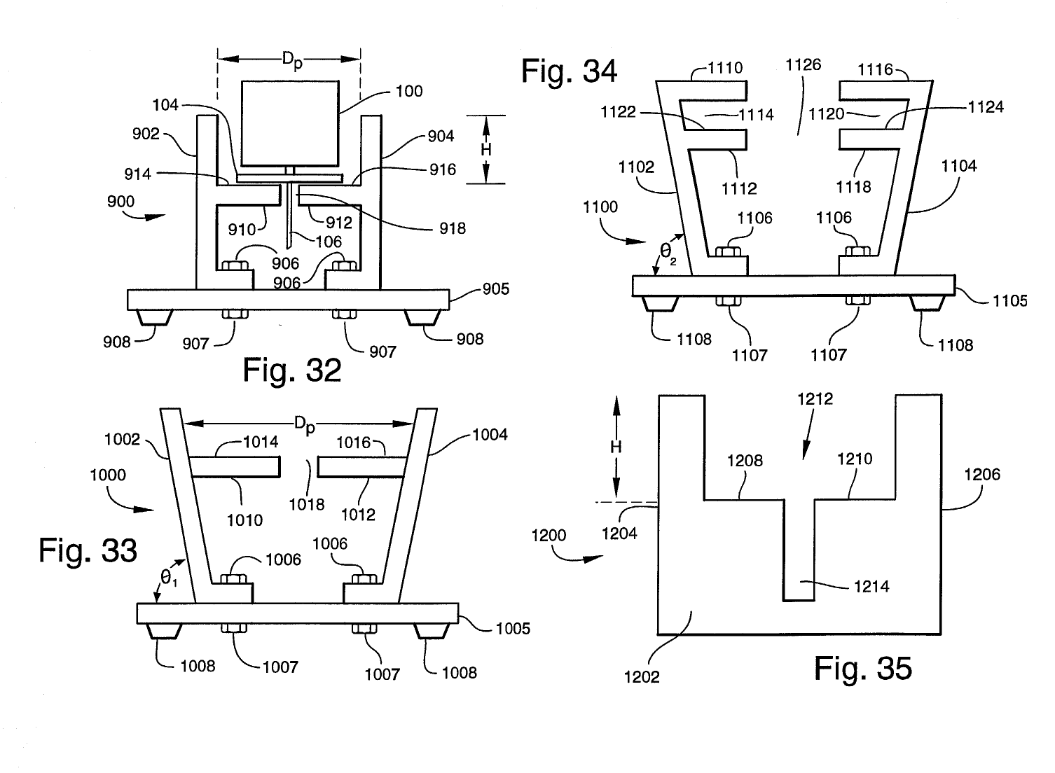

Referring to FIG. 32, there is shown an end view of an alternate embodiment of the saw holder of the present invention. Saw holder 900 comprises upstanding wall members 902 and 904. Wall members 902 and 904 are movably attached to a pair of lateral support members, one of which being member 905, that have generally the same construction as lateral members 160 and 162 that were previously described herein (see FIGS. 12 and 16E). Screws 906 are sized to be inserted through slots in the pair of lateral support members. Screws 906 and nuts 907 allow wall members 902 and 904 to be laterally moved to vary the distance Dp between wall members 902 and 904 in order to accommodate jig saws of different sizes. Cleats 908 are attached to lateral support member 905 as well as the lateral support member that is not shown. Cleats 908 function in the same manner as cleats 342 discussed above (see FIGS. 16A and 16F). Wall member 902 includes lip 910. Lip 910 longitudinally extends for substantially the entire length of wall member 902. In one embodiment, lip 910 is generally perpendicular to wall member 902. Similarly, wall member 904 includes lip 912. Lip 912 longitudinally extends for substantially the entire length of wall member 904. In one embodiment, lip 912 is generally perpendicular to wall member 904. Lips 910 and 912 have surfaces 914 and 916, respectively, for receiving portions of bottom surface 105 of saw base portion 104 (see FIG. 5C). Longitudinally extending channel 918 is located between lips 914 and 916. Channel 918 receives blade 106 of saw 100. In order to mount saw 100 on saw holder 900, the user positions saw 100 so that blade 106 is disposed within channel 918 and portions of bottom surface 105 of saw base 104 rest upon surfaces 914 and 916. Each wall portion 902 and 904 has a portion extending upward from lips 914 and 916, respectively, that has a predetermined height H. In a preferred embodiment, height H is at least half of the height of saw 100 (measured from base 104 to the top surface of body 102 of saw 100).

Referring to FIG. 33, there is shown an end view of an alternate embodiment of the saw holder of the present invention. Saw holder 1000 comprises upstanding wall members 1002 and 1004. Wall members 1002 and 1004 are movably attached to a pair of lateral support members, one of which being member 1005, that have generally the same construction as lateral members 160 and 162 that were previously described herein (see FIGS. 12 and 16E). Wall members 1002 and 1004 are angulated with respect to the lateral support members. In a preferred embodiment, the degree of angulation θ1 is between about 10 and 45. Screws 1006 are sized to be inserted through slots in the pair of lateral support members. Screws 1006 and nuts 1007 allow wall members 1002 and 1004 to be laterally moved to vary the distance D_{P} between wall members 1002 and 1004 in order to accommodate jig saws of different sizes. Cleats 1008 are attached to the lateral support members (i.e. member 1005) as well as the lateral support member that is not shown. Cleats 1008 function in the same manner as cleats 342 discussed above (see FIGS. 16A and 16F). Wall member 1002 includes lip 1010. Lip 1010 longitudinally extends for substantially the entire length of wall member 1002. Similarly, wall member 1004 includes lip 1012. Lip 1012 longitudinally extends for substantially the entire length of wall member 1004. Lips 1010 and 1012 have surfaces 1014 and 1016, respectively, for receiving portions of bottom surface 105 of saw base portion 104 (see FIG. 5C). Longitudinally extending channel 1018 is located between lips 1014 and 1016. Channel 1018 receives blade 106 of saw 100. In order to mount saw 100 on saw holder 1000, the user positions saw 100 so that blade 106 is disposed within channel 1018 and portions of bottom surface 105 of saw base 104 rest upon surfaces 1014 and 1016.

Referring to FIG. 34, there is shown an end view of an alternate embodiment of the saw holder of the present invention. Saw holder 1100 comprises upstanding wall members 1102 and 1104. Wall members 1102 and 1104 are movably attached to a pair of lateral support members, one of which being member 1105, that have generally the same construction as lateral members 160 and 162 that were previously described herein (see FIGS. 12 and 16E). Wall members 1102 and 1104 are angulated with respect to the lateral support members. In a preferred embodiment, the degree of angulation θ2 is between about 10 and 45. Screws 1106 are sized to be inserted through slots in the pair of lateral support members. Screws 1106 and nuts 1107 allow wall members 1102 and 1104 to be laterally moved to vary the distance D_{P} between wall members 1102 and 1104 in order to accommodate jig saws of different sizes. Cleats 1108 are attached to the lateral support members (i.e. member 1105) as well as the lateral support member that is not shown. Cleats 1108 function in the same manner as cleats 342 discussed above (see FIGS. 16A and 16F). Wall member 1102 includes lips 1110 and 1112. Lips 1110 and 1112 longitudinally extend for substantially the entire length of wall member 1102 and are separated by channel 1114. Channel 1114 is sized for receiving a portion of bottom portion 104 of saw 100. Lip 1112 has surface 1122. Similarly, wall member 1104 includes lips 1116 and 1118. Lips 1116 and 1118 longitudinally extend for substantially the entire length of wall member 1104 and are separated by channel 1120. Channel 1120 is sized for receiving a portion of bottom portion 104 of saw 100. Lip 1118 has surface 1124. Longitudinally extending channel 1126 is located between wall members 1102 and 1104. Channel 1126 receives blade 106 of saw 100. In order to mount saw 100 on saw holder 1100, the user positions saw 100 so that blade 106 is disposed within channel 1126 and portions of bottom surface 105 of saw base 104 rest upon surfaces 1122 and 1124.

Referring to FIG. 35, there is shown a further embodiment of the saw holder of the present invention. Saw holder 1200 is similar to saw holder 200 (see FIG. 14A) but without portions 208 and 210. Saw holder 1200 is of uni-body construction which can be realized by plastic injection molding. Saw holder 1200 can also be made from materials such as wood, rubber, fiberglass, graphite or other composite materials. However, it is to be understood that other materials can be used as well, e.g. metal. Saw holder 1200 comprises body 1202 and walls portions 1204 and 1206. Wall portion 1204 defines ledge 1208. Similarly, wall portion 1206 defines ledge 1210. Saw holder 1200 further includes an upper channel between wall portions 1204 and 1206 that is indicated by numeral 1212. Channel 1212 longitudinally extends throughout body 1202 and is sized for receiving saw 100. Saw holder 1200 further includes lower channel 1214 between wall portions 1204 and 1206. Channel 1214 longitudinally extends throughout body 1202. Channel 1214 is sized for receiving blade 106 of saw 100. When saw 100 is disposed within channel 1212, portions of bottom surface 105 of saw 100 contact ledges 1208 and 1210 and blade 106 is disposed in lower channel 1214.

Each wall portion 1204 and 1206 has a portion 1204a and 1206b, respectively, that extends upward from ledges 1208 and 1210, respectively. Portion 1204a and 1206b each have a predetermined height H. In a preferred embodiment, height H is at least half of the height of saw 100 (measured from base 104 to the top surface of body 102 of saw 100).

Jig saw holder 1200 may be fabricated or formed as a stand alone device, as illustrated in FIG. 35, or formed from a portion of the carrying case with which the jig saw is sold. In such an embodiment, the interior of the jig saw carrying case is configured to provide the structure shown in FIG. 35. However, such structure would not interfere with closing the jig saw carrying case. In another embodiment, the structure shown in FIG. 35 is formed on the exterior of the jig saw carrying case.

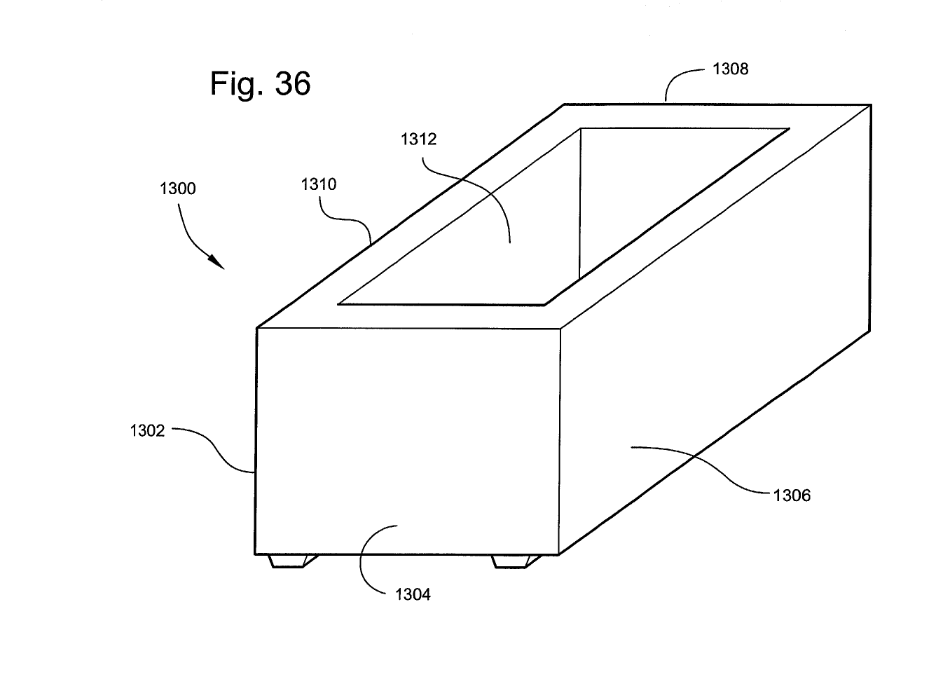

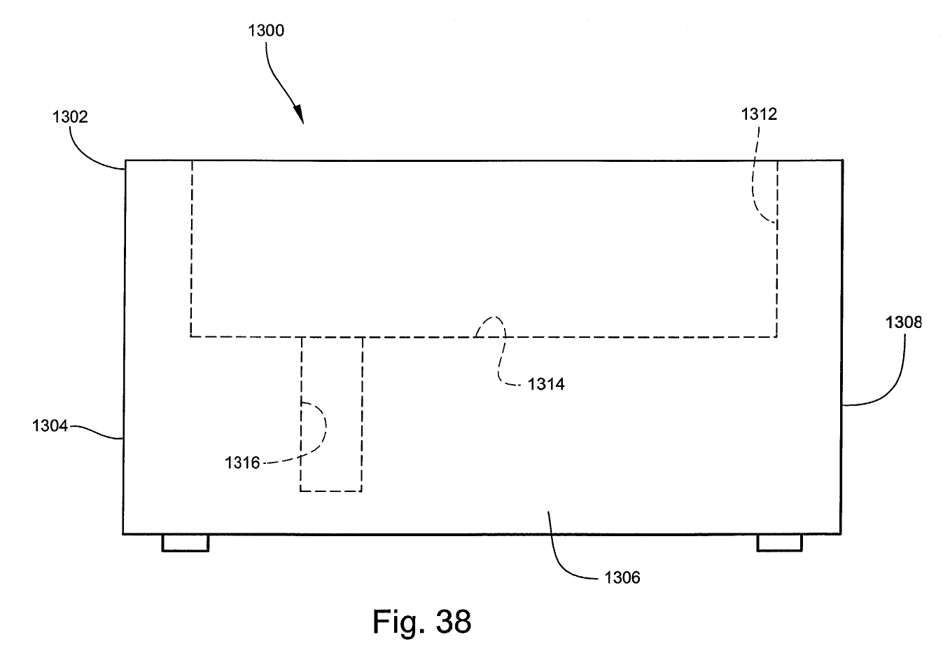

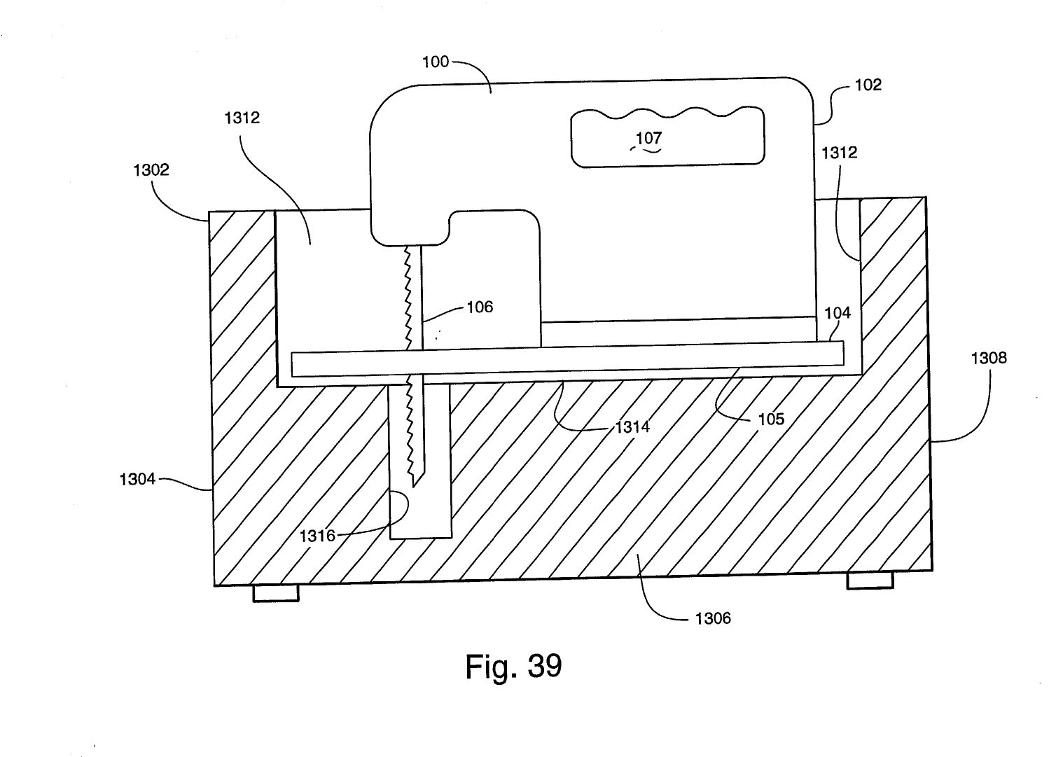

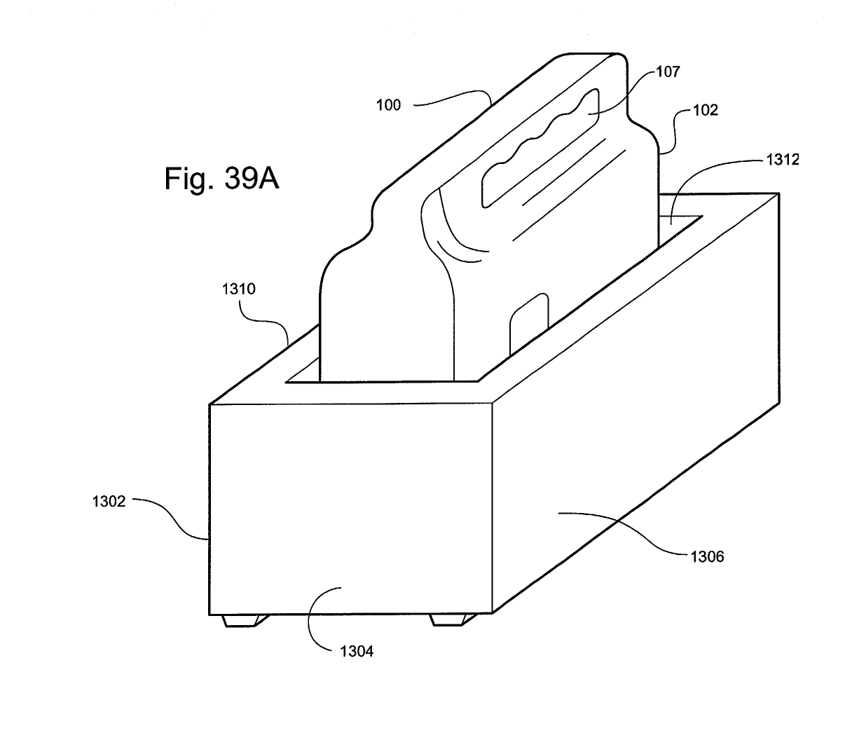

Referring to FIGS. 36-39A, there is shown alternate saw holder 1300 of the present invention. Holder 1300 comprises body 1302. Body 1302 comprises wall portions 1304, 1306, 1308, 1310 and bottom portion 1314 which define interior region 1312 (also shown in phantom in FIG. 38). Interior region 1312 is sized for receiving a portion of jig saw 100. Specifically, interior region 1312 has length and width dimensions that allow jig saw 100 to be removably positioned within interior region 1312. Bottom portion 1314 receives bottom portion 105 of saw 100. Body portion 100 further includes cavity or bore 1316 that is sized for receiving saw blade 106. FIGS. 39 and 39A illustrates saw 100 positioned within interior region 1312.

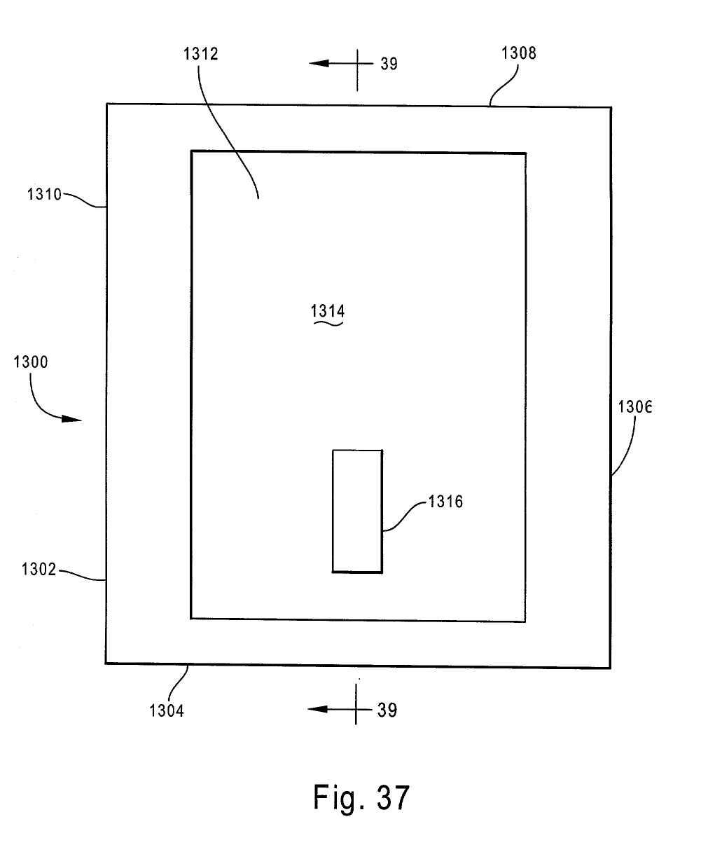

Jig saw holder 1300 may be fabricated or formed as a stand alone device, as illustrated in FIG. 37, or formed from a portion of the carrying case with which the jig saw is sold. In such an embodiment, the interior of the jig saw carrying case is configured to provide the structure shown in FIG. 37. However, such structure would not interfere with closing the jig saw carrying case. In another embodiment, the structure shown in FIG. 37 is formed on the exterior of the jig saw carrying case.

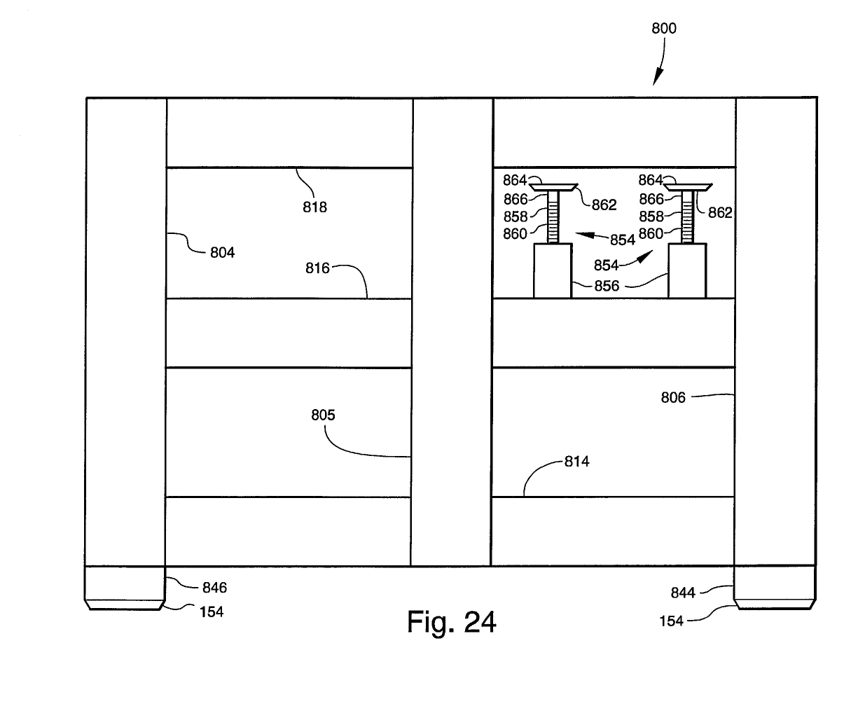

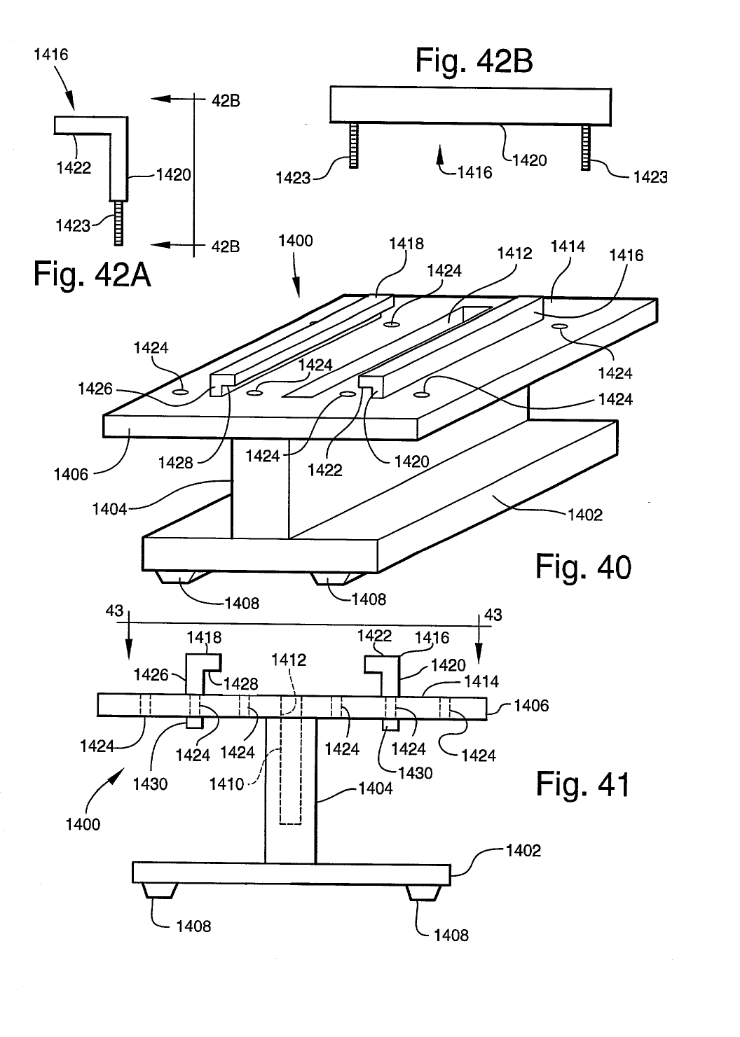

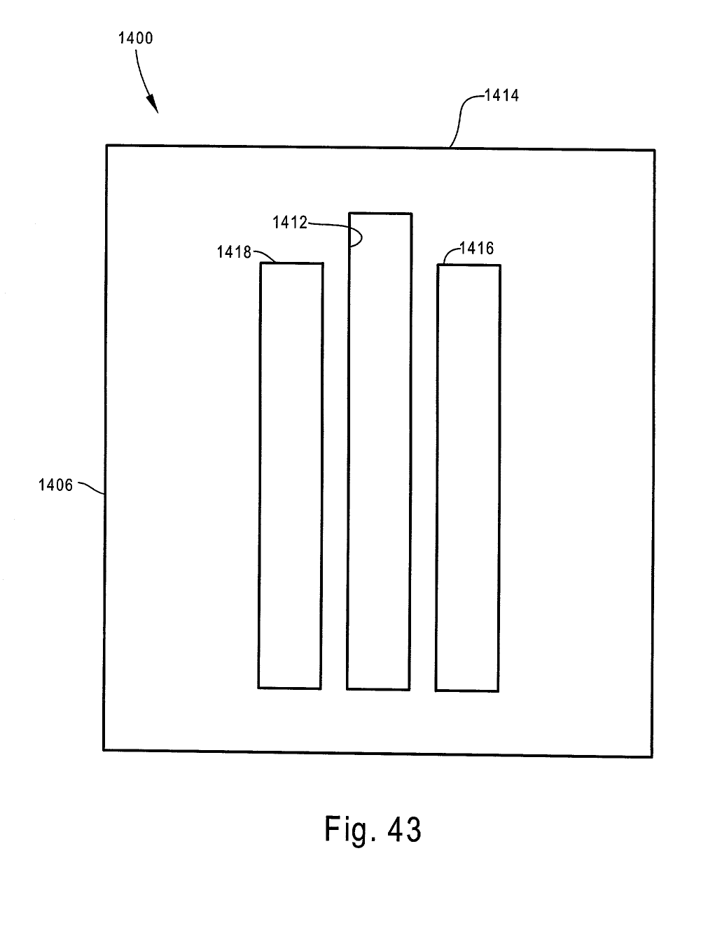

Referring to FIGS. 40, 41, 41A, 42A, 42B and 43, there is shown alternate saw holder 1400 of the present invention. Saw holder 1400 comprises base portion 1402, wall portion 1404 and top portion 1406. Base portion 1402 has cleats 1408 attached thereto which function in the same manner as cleats 154 (see FIGS. 23 and 24). Wall portion 1404 includes a longitudinally extending slot 1410 that is sized to receive blade 106 of saw 100. Top portion 1406 includes a longitudinally extending slot 1412 that is aligned with slot 1410. Top portion 1406 includes top surface 1414. Saw holder 1400 further includes guides 1416 and 1418. Guides 1416 and 1418 are removably attached to top portion 1406. Guide 1416 comprises generally vertical portion 1420 and generally horizontal portion 1422. Guide 1416 further includes threaded members 1423 that are sized for insertion into bores 1424 that are formed in top portion 1406. Similarly, guide 1418 comprises generally vertical portion 1426 and generally horizontal portion 1428. Guide 1418 further includes threaded members (not shown but which are similar to threaded members 1423) that are sized for insertion into bores 1424. In a preferred embodiment, guides 1416 and 1418 are substantially identically to one another in construction.

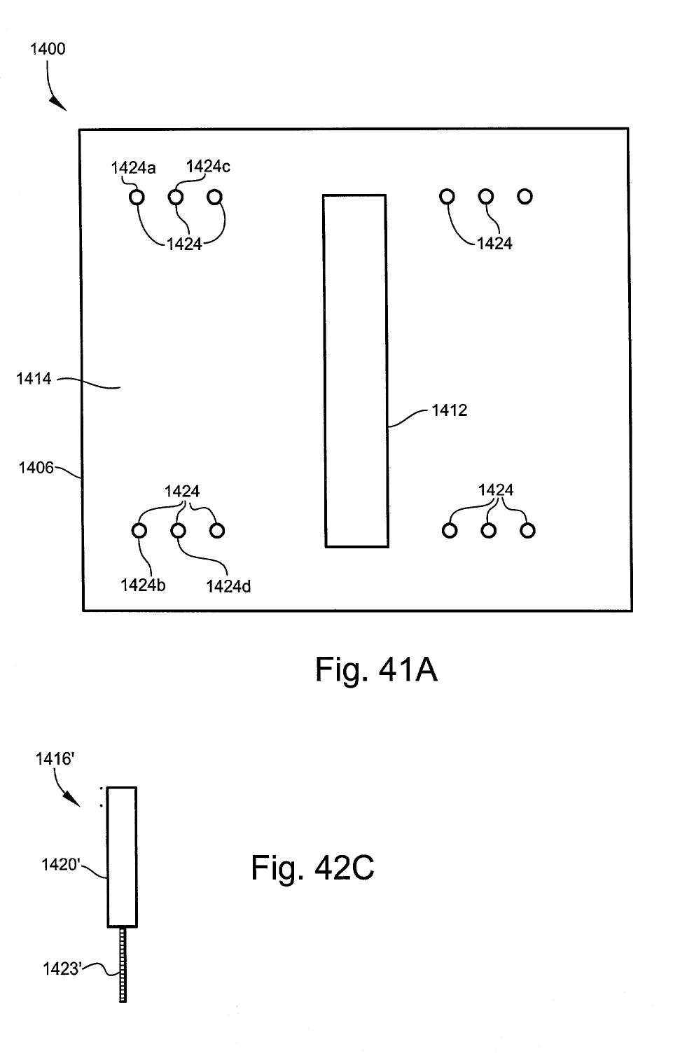

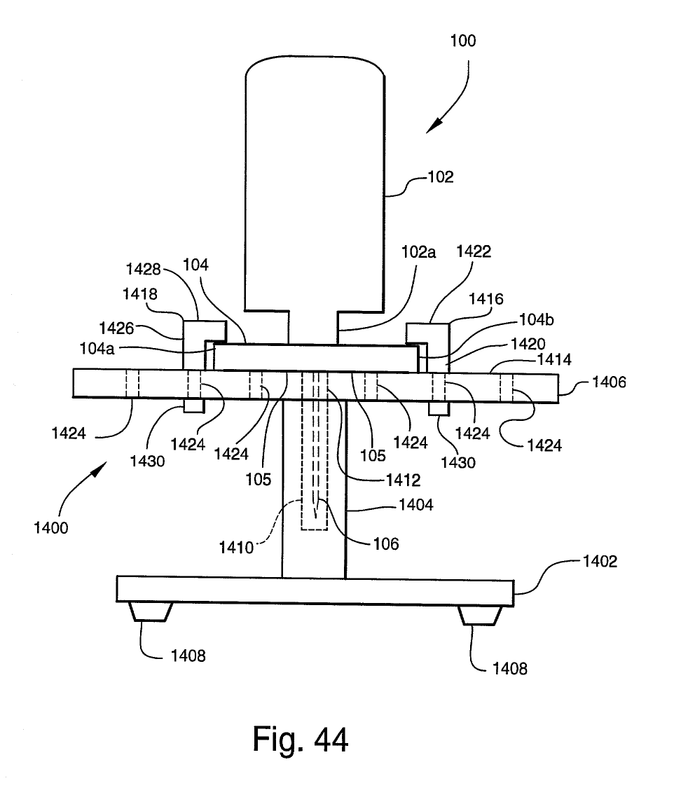

Referring to FIGS. 41 and 41A, nuts 1430 are threadedly engaged to threaded members 1423 of guide 1416 and the threaded members of guide 1418. Referring to FIG. 41A, bores 1424 are arranged in sets that are positioned at predetermined distances from slot 1412. For example, bores 1424a and 1424b comprise one set of bores, and bores 1424c and 1424d comprise another set of bores. Such a configuration allows guides 1416 and 1418 to be moved laterally with respect to slot 1412. Referring to FIG. 44, when jig saw 100 is mounted on saw holder 1400, blade 106 is disposed within slot 1410, bottom surface 105 contacts surface 1414, and portions of base 104 are positioned under the generally horizontal portions 1422 and 1428 of guides 1416 and 1418, respectively. Since guides 1416 and 1418 can be repositioned with respect to slot 1410, saws having bases 104 of varying sizes can be mounted on saw holder 1400. Specifically, if saw 100 has a base (i.e. base 104) that is wider than the base shown in FIG. 44, guides 1416 and 1418 can be moved laterally with respect to and away from slot 1412 in order to accommodate saws having relatively larger saw bases (i.e. base 104). It is to be understood that guides 1416 and 1418 can be configured to accommodate saw bases (i.e. base 104) of varying sizes. Specifically, portions 1420 and 1422 of guide 1416 and portions 1426 and 1428 of guide 1418 can be lengthened or shortened to accommodate jig saws having saw bases of various sizes. Furthermore, horizontal portions 1422 and 1428 can be angulated with respect to vertical portions 1420 and 1426, respectively, to accommodate saw bases of varying sizes.

In alternate embodiment, guides 1416 and 1418 are configured without horizontal portions 1422 and 1428, respectively. Accordingly, FIG. 42C illustrates an end view of an alternate guide 1416′ that does not have a horizontally extending portion. Guide 1416′ includes vertical portion 1420′ and threaded portion 1423′ which function in the same manner as vertical portion 1420 and threaded portion 1423, respectively, described in the foregoing description. The alternate guide to be used in place of guide 1418 is generally the same in construction as guide 1416′. Thus, for purposes of brevity, only guide 1416′ is shown.

Saw holder 1400 can be fabricated from any suitable material, e.g. metal, plastic, graphite, wood, etc.

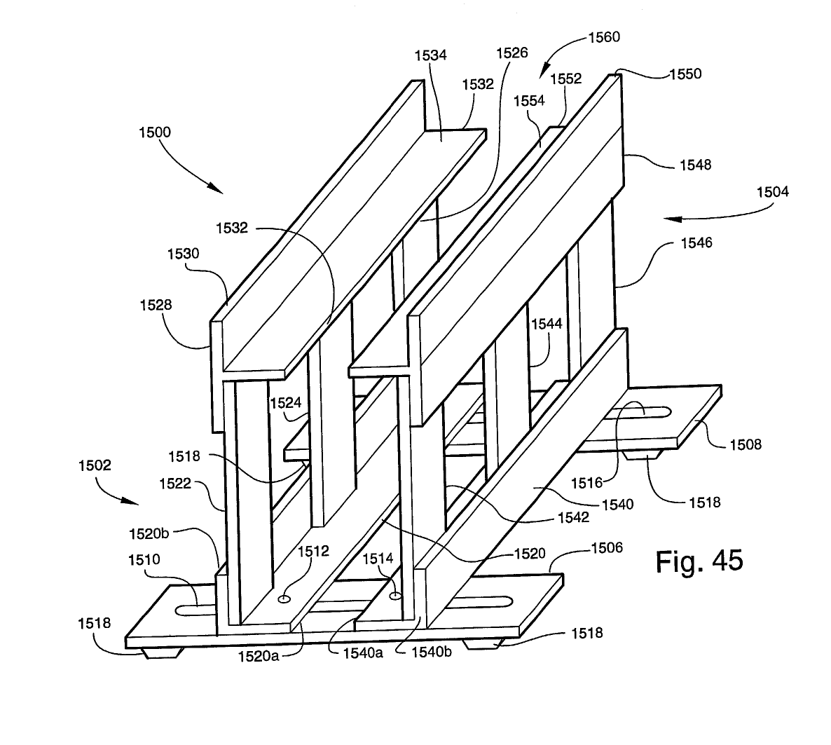

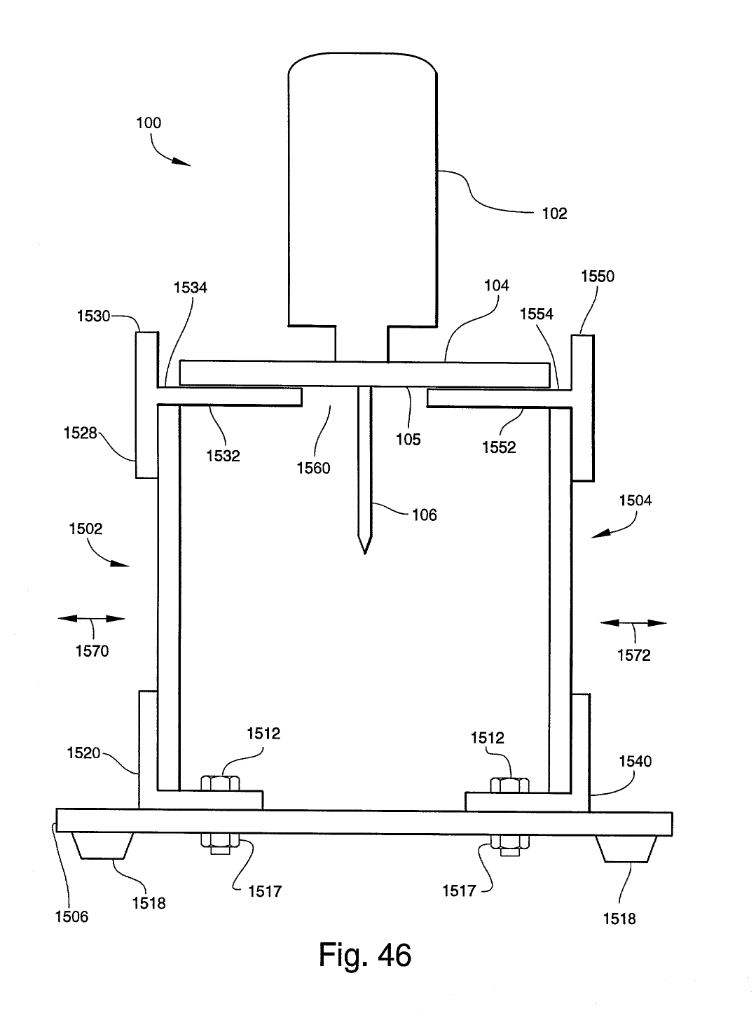

Referring to FIGS. 45 and 46, there is shown a further embodiment of the saw holder of the present invention. Saw holder 1500 generally comprises wall portions 1502 and 1504. Wall portions 1502 and 1504 are movably attached to lateral support members 1506 and 1508. Members 1506 are generally the same in construction as lateral members 160 and 162 previously discussed herein (see FIG. 16E). Member 1506 includes a longitudinally extending slot 1510 sized for receiving screws 1512 and 1514. Member 1508 includes a longitudinally extending slot 1516 that is sized for receiving screws (not shown, but which are similar to screws 1512 and 1514). Nuts 1517 are threadedly engaged to the screws disposed within slots 1510 and 1516 (i.e. screws 1512). Cleats 1518 are attached to the bottom sides of members 1506 and 1508 and function in the same manner as cleats 154 previously discussed herein (see FIG. 8).

Referring to FIG. 45, wall portion 1502 generally comprises base member 1520, vertical support members 1522, 1524 and 1526, and top portion 1528. Base member 1520 generally comprises horizontal portion 1520a and generally vertical portion 1520b. In one embodiment, horizontal portion 1520a is generally perpendicular to vertical portion 1520b. Vertical support members 1522, 1524 and 1526 are connected to and between base portion 1520 and top portion 1528. Top portion 1528 generally comprises vertical portion 1530 and generally horizontal portion 1532. In one embodiment, horizontal portion 1532 is generally perpendicular to vertical portion 1530. Horizontal portion 1532 has top surface 1534. Vertical members 1522, 1524 and 1526 can be connected to bottom and top portions 1520 and 1528, respectively, in various ways depending upon the materials from which saw holder 1500 is fabricated. For example, if saw holder 1500 is fabricated from metal, then screws, rivets and welding can be used to attach vertical members 1522, 1524 and 1526 to bottom and top portions 1520 and 1528, respectively. If saw holder 1500 is fabricated from plastic, then rivets, screws or ultrasonic welding can be used. If wood is used, then adhesives, nails or staples can be used to attach vertical members 1522, 1524 and 1526 to bottom and top portions 1520 and 1528, respectively.

Referring to FIG. 45, wall portion 1504 generally comprises base member 1540, vertical support members 1542, 1544 and 1546, and top portion 1548. Base member 1540 generally comprises horizontal portion 1540a and generally vertical portion 1540b. In one embodiment, horizontal portion 1540a is generally perpendicular to vertical portion 1540b. Vertical support members 1542, 1544 and 1546 are connected to and between base portions 1540 and top portion 1548. Top portion 1548 generally comprises vertical portion 1550 and generally horizontal portion 1552. In one embodiment, horizontal portion 1552 is generally perpendicular to vertical portion 1550. Horizontal portion 1552 has top surface 1554. Vertical members 1542, 1544 and 1546 can be connected to bottom and top portions 1540 and 1548, respectively, in various ways depending upon the materials from which saw holder 1500 is fabricated. For example, if saw holder 1500 is fabricated from metal, then screws, rivets and welding can be used to attach vertical members 1542, 1544 and 1546 to bottom and top portions 1540 and 1548. If saw holder 1500 is fabricated from plastic, then rivets, screws or ultrasonic welding can be used. If wood is used, then adhesives, nails or staples can be used to attach vertical members 1542, 1544 and 1546 to bottom and top portions 1540 and 1548.

Referring to FIG. 46, wall portions 1502 and 1504 are separated by space or gap 1560. When jig saw 100 is mounted on saw holder 1500, portions of bottom surface 105 of saw bottom portion 104 contact top surfaces 1534 and 1554 and blade 106 is disposed within gap or space 1560. In order to accommodate jig saws of varying sizes, nuts 1517 can be loosened to allow wall portions 1502 and 1504 to be moved laterally as indicated by arrows 1570 and 1572. Once the desired positions of wall portions 1502 and 1504 are obtained, nuts 1517 are then tightened to prevent wall portions 1502 and 1504 from moving.

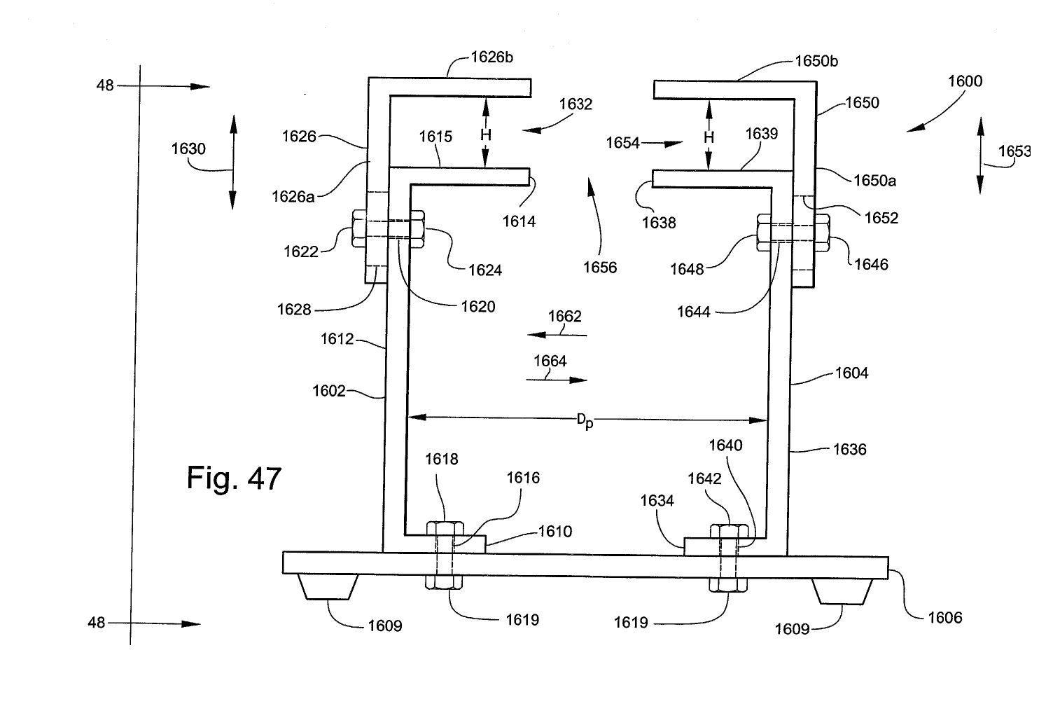

Referring to FIGS. 47-51, there is shown another embodiment of the saw holder of the present invention. Saw holder 1600 generally comprises longitudinally extending walls 1602 and 1604, and lateral support members 1606 and 1608. Walls 1602 and 1604 are movably attached to lateral support members 1606 and 1608. Lateral support or base members 1606 and 1608 have the same purpose and function in the same manner as lateral support members 160 and 162 previously described herein (see FIG. 19A). Cleats 1609 are attached to the bottom sides of support members 1606 and 1608 and have the same purpose as cleats 342 which were previously described herein (see FIG. 16G).

Wall 1602 comprises bottom 1610, generally vertical portion 1612 and top portion 1614. Top portion 1614 has top surface 1615. Bottom portion 1610 includes openings 1616 that are sized for receiving screws 1618. Nuts 1619 are threadedly engaged with screws 1618. The purposes of screws 1618 and nuts 1619 will be discussed in the ensuing description. Vertical portion 1612 includes openings 1620 that are sized for receiving screws 1622. Nuts 1624 are threadedly engaged with screws 1622. The purpose of screws 1622 and nuts 1624 is discussed in detail in the ensuing description.

Referring to FIGS. 47-50, saw holder 1600 further includes bracket 1626 that is movably attached to wall 1602. Bracket 1626 comprises portion 1626a and 1626b which are substantially perpendicular to one another. Bracket 1626 includes slots 1628 which are formed in portion 1626a. Each slot 1628 is substantially aligned with a corresponding opening 1620 in vertical portion 1612. Each slot 1628 has a predetermined length L and is sized to receive a corresponding screw 1622. Thus, when nuts 1624 are loosened, bracket 1626 can be moved upward or downward, as indicated by arrow 1630, with respect wall 1602. Top portion 1614 and portion 1626b of bracket 1626 define longitudinally extending channel 1632 which has a height H. Channel 1632 serves the same purpose as channel 62 (FIG. 2) and channel 330 (see FIG. 16B) which were previously discussed herein. Specifically, channel 1632 receives a portion of base portion 104 of saw 100 (see FIG. 5C). Since bracket 1626 is movable in an upward or downward direction with respect to wall 1602, the height H of channel 1632 can be increased or decreased according to the size of the portion of the saw base portion (i.e. base portion 104) that is to be inserted within channel 1632.

Referring to FIG. 47, wall 1604 comprises bottom portion 1634, generally vertical portion 1636 and top portion 1638. Top portion 1638 has top surface 1639. Bottom portion 1634 includes openings 1640 that are sized for receiving screws 1642. Nuts 1619 are threadedly engaged with screws 1642. The purposes of nuts 1619 and screws 1642 will be discussed in the ensuing description. Vertical portion 1636 includes openings 1644 that are sized for receiving screws 1646. Nuts 1648 are threadedly engaged with screws 1646. The purpose of screws 1646 and nuts 1648 is discussed in detail in the ensuing description.

Referring to FIGS. 47-50, saw holder 1600 further includes bracket 1650 that is movably attached to wall 1604. Bracket 1650 is substantially identical in construction to bracket 1626. Bracket 1650 comprises portion 1650a and 1650b which are substantially perpendicular to one another. Bracket 1650 includes slots 1652 which are formed in portion 1650a. Each slot 1652 is substantially aligned with a corresponding opening 1644 in vertical portion 1636. Each slot 1652 has a predetermined length L (similar to slot 1628) and is sized to receive screw 1646. Thus, when nuts 1648 are loosened, bracket 1650 can be moved upward or downward, as indicated by arrow 1653, with respect wall 1604. Top portion 1638 and portion 1650b of bracket 1650 define longitudinally extending channel 1654 which has a height H. Channel 1654 serves the same purpose as channel 62 (FIG. 2) and channel 330 (see FIG. 16B) which were previously discussed herein. Specifically, channel 1654 receives a portion of base portion 104 of saw 100 (see FIG. 5C). Since bracket 1650 is movable in an upward or downward direction with respect to wall 1604, the height H of channel 1654 can be increased or decreased according to the size of the portion of the saw base portion (i.e. base portion 104) that is to be inserted within channel 1654.

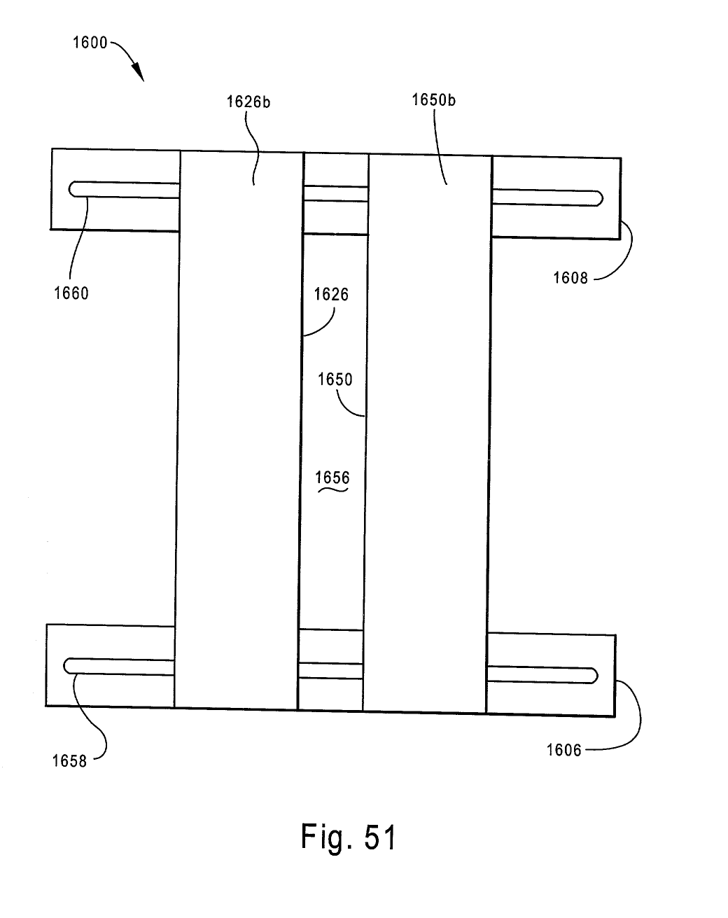

Referring to FIGS. 47 and 51, lateral support members 1606 and 1608 have longitudinally extending slots 1658 and 1660, respectively, that are sized for receiving screws 1618 and 1642. FIG. 47 shows an end view of saw holder 1600 wherein screws 1618 and 1642 are disposed within slot 1658 of lateral support member 1606. However, it is to be understood that there are also screws (similar to screws 1618 and 1642) located at the opposite end of saw holder 1600 that are disposed through corresponding openings (similar to openings 1616 and 1640) in walls 1602, 1604 and through slot 1660 of lateral support member 1608 in order to removably attach the opposite ends of walls 1602 and 1604 to lateral support member 1608.

Referring to FIG. 47, top portion 1614 and bracket 1626 are separated from top portion 1638 and bracket 1650 by space or gap 1656. When jig saw 100 is mounted on saw holder 1600, portions of bottom surface 105 of saw bottom portion 104 contact or rest upon top surfaces 1615 and 1639 and blade 106 is disposed within gap or space 1656. In order to accommodate jig saws of varying sizes, nuts 1619 are loosened to allow walls 1602 and 1604 to be moved laterally, as indicated by arrows 1662 and 1664, in order to vary the distance Dp between walls 1602 and 1604. Once the desired positions of walls 1602 and 1604 are obtained, nuts 1619 are then tightened to prevent walls 1602 and 1604 from moving.

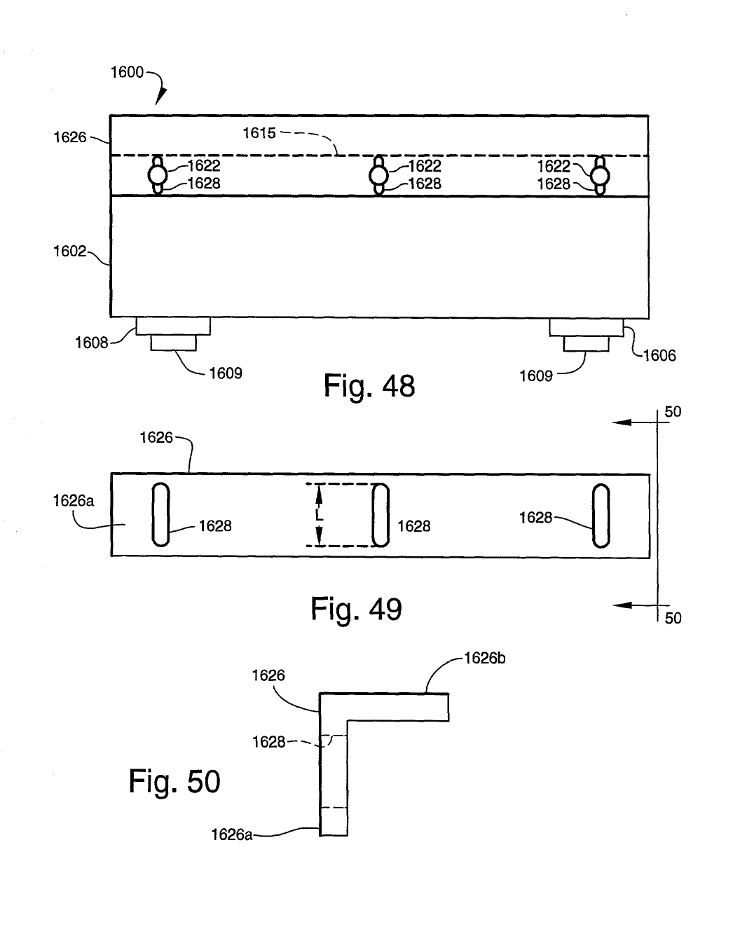

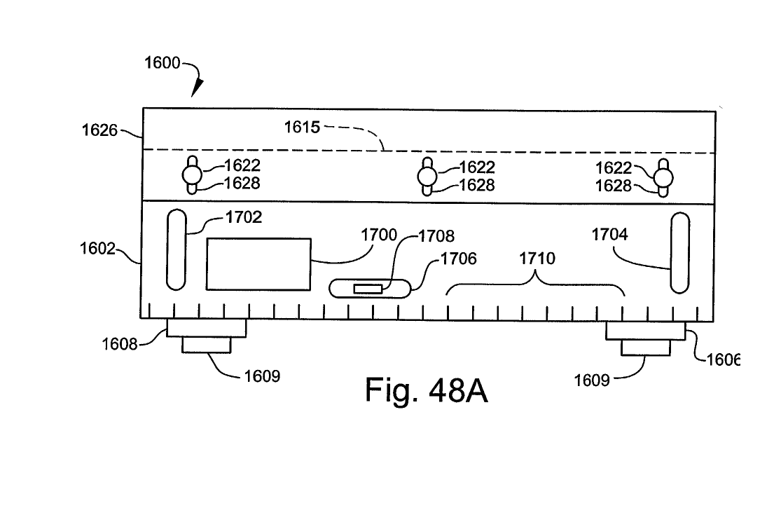

Referring to FIG. 48A, there is shown a view of saw holder 1600 that is similar to the view in FIG. 48. However, the view in FIG. 48A shows optional features such as (i) receptacle 1700 for storing jig saw blades, (ii) electrical power cord clips 1702 and 1704 to which the electrical power cord of the jig saw is secured, (iii) level device 1706 which contains a level bubble 1708 and (iv) measurement indicia 1710 which is similar to the indicia found on measuring tapes, yard sticks, rulers, etc. Receptacle 1700, clips 1702, 1704 and level device 1706 are attached to wall 1602. Receptacle 1700 includes a blade guide therein (not shown) that has a plurality of openings therein for receiving the jig saw blades. In one embodiment, receptacle 1700 includes a cover (not shown) that is movable attached thereto and functions as a cover for receptacle 1700. Indicia 1710 may be formed on both sides of jig saw 1600. Electrical power cord clips 1702 and 1704 are configured to enable a user to wrap the electrical power cord of the jig saw around clips 1702 and 1704. FIG. 48A illustrates one example of where receptacle 1700, clips 1702, 1704 and level device 1708 can be attached to saw holder 1600. It is to be understood that receptacle 1700, clips 1702, 1704 and level device 1706 can be attached to other portions of jig saw holder 1600. It is also to be understood that receptacle 1700, clips 1702, 1704 and level device 1706 can be used on all other embodiments of the jig saw of the present invention that were described in the foregoing description.

Saw holder 1600 may be fabricated from any suitable material, e.g. metal, plastic, wood, etc.

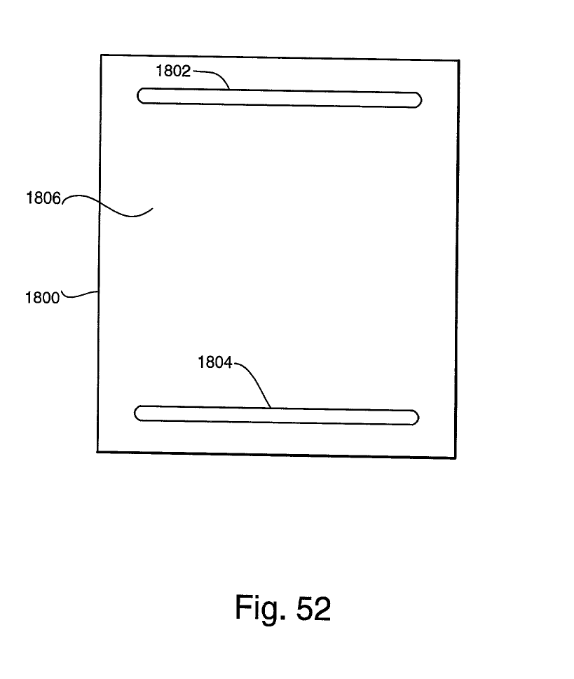

Referring to FIG. 52, there is shown an alternate base member that can used in place of lateral support or base members 160, 162 (see FIG. 16E) and lateral support or base members 1606 and 1608. Base member 1800 comprises a single piece member that has extending slots 1802 and 1804 that function in the same manner as slots 164 and 166 (see FIG. 16E) and slots 1658 and 1660 (see FIGS. 47 and 51). Base member has top side 1806 which is generally flat. Base member 1800 can be configured to have any shape, e.g. square, rectangular, circular, triangular, trapezoidal, etc. Cleats such as cleats 1609 can be attached to the bottom side (not shown) of base member 1800.

Thus, the apparatus of the present invention:

a) is easy to use;

b) inexpensive to manufacture;

c) provides safe positioning of the jig saw when not being used thereby preventing injuries to personnel and damage to the jig saw;

d) can be configured for use with jig saws of different sizes;

e) can be used to secure a work piece and allows a user to accurately cut the work piece;

f) is lightweight and easy to transport and store; and

g) can be sold in kit form.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A holder for a jig saw, comprising:
a base member;
a pair of opposing support members movably attached to the base member such that the support members can be moved toward or away from one another, each support member having a jig saw receiving surface for receiving a first portion of the base of a jig saw, the support members being spaced apart from each other so as to define a region for receiving a blade of the jig saw when each jig saw receiving surface receives a corresponding portion of the base of the jig saw; and
a pair of adjustable members, each adjustable members being movably attached to a corresponding support member adjacent to the jig saw receiving surface of that support member, each adjustable member and the corresponding jig saw receiving surface cooperating to define a jig saw base receiving region for receiving a portion of the base of the jig saw, the position of each adjustable member being adjustable so as to vary the size of the jig saw receiving region.

2. The jig saw holder according to claim 1 wherein each jig saw base receiving surface extends for a predetermined length.

3. The jig saw holder according to claim 2 wherein each jig saw base receiving surface extends for substantially the entire length of the corresponding support member.

4. The jig saw holder according to claim 1 wherein each support member is generally upright.

5. The jig saw holder according to claim 1 wherein each support member is generally upright.

6. The jig saw holder according to claim 1 wherein each support member is angulated with respect to the base member.

7. The jig saw holder according to claim 1 wherein each support member has a top portion and a bottom portion, each adjustable member being movably attached to the support member adjacent the top portion, the bottom portion being attached to the base member.

8. The jig saw holder according to claim 1 wherein each adjustable member moves vertically with respect to the corresponding support member.

9. The jig saw holder according to claim 3 wherein the jig saw base receiving region of each support member comprises a channel.

10. The jig saw holder according to claim 1 wherein the base member comprises a single piece member.

11. The jig saw holder according to claim 10 wherein the base member is generally flat.

12. The jig saw holder according to claim 10 wherein the base member is generally square shaped.

13. The jig saw holder according to claim 10 wherein the base member is generally rectangular shaped.

14. The jig saw holder according to claim 1 including a plurality of fasteners being configured to be (i) tightened to prevent movement of the support members with respect to the base member, and (ii) loosened to allow movement of the support members with respect to the base member.

15. The jig saw holder according to claim 1 including means for preventing movement of the support members with respect to the base member, and enabling movement of the support members with respect to the base member.

16. The jig saw holder according to claim 1 wherein the base member comprises at least two elongate members, laterally positioned with respect to the support members, the support members being movably attached to the lateral members.

17. The jig saw holder according to claim 1 wherein each adjustable member moves vertically with respect to the corresponding support member.

18. The jig saw holder according to claim 1 further comprising at least one level device attached to one of the support members, the level device having at least level bubble therein.

19. The jig saw holder according to claim 1 further comprising a pair of power cord clips attached to one of the support members for securing an electrical power cord of a jig saw.

20. The jig saw holder according to claim 1 further comprising a receptacle attached to one of the support members for holding jig saw blades.

21. The jig saw holder according to claim 1 further comprising measurement indicia on at least one of the support members.

22. The jig saw holder according to claim 1 wherein the base member has a top surface confronting the support members and a bottom a surface, the jig saw holder further comprising a plurality of cleats attached to the bottom surface of the base.

23. The jig saw holder according to claim 21 wherein the cleats are fabricated from a material that has a relatively high coefficient of friction.

24. A jig saw holder comprising a body having a surface for receiving abase of a jig saw and defining a generally vertically extending cavity sized for receiving at least a portion of a blade of the jig saw when the base of the jig saw is positioned upon the surface of the body, the body further comprising a first wall and a second wall which upwardly extending from the surface of the body, the first wall being positioned on one side of the cavity, the second wall being positioned on the other side of the cavity, the walls and surface of the body cooperating to define a jig saw base receiving region.

25. The jig saw holder according to claim 24 further comprising a third wall and a fourth wall, the third wall being positioned on one side of the cavity and generally lateral to the first and second walls, the fourth wall being positioned on the other side of the cavity and generally lateral to the first and second walls.

26. A jig saw holder comprising a body having a surface for receiving a base of a jig saw and defining a longitudinally extending slot having a depth sufficient for receiving at least a portion of a blade of the jig saw when the base of the jig saw is positioned upon the surface of the body, the body further comprising a pair of guides movably attached to the body and positioned upon the surface of the body, one guide being positioned on one side of the slot, the other guide being positioned on the other side of the slot, the guides and surface of the body cooperating to define a jig saw base receiving region such that the base of the jig saw is between the guides when the jig saw base is positioned upon the surface of the body.

27. The jig saw holder according to claim 26 wherein the guides are generally parallel to one other.

28. The jig saw holder according to claim 26 wherein each guide comprises a generally vertical member.

29. The jig saw holder according to claim 28 wherein each guide further comprises a lateral portion attached to the generally vertical portion, the lateral portion extending over a portion of the jig saw base when the jig saw base is positioned upon the surface of the body.
